(19) United States
(12) Patent Application Publication
(10) Pub. No.: US 2024/0046391 A1
(43) Pub. Date: Feb. 8, 2024

(54) METHODS AND SYSTEM FOR MANAGING INTELLECTUAL PROPERTY USING A BLOCKCHAIN

(71) Applicant: Moses T. Ma, Mill Valley, CA (US)

(72) Inventor: Moses T. Ma, Mill Valley, CA (US)

(21) Appl. No.: 18/454,398

(22) Filed: Aug. 23, 2023

Related U.S. Application Data
(63) Continuation of application No. 17/509,801, filed on Oct. 25, 2021, now abandoned.
Application No. 17/509,801 is a continuation of application No. 15/942,988, filed on Apr. 2, 2018, now abandoned.
(60) Provisional application No. 62/481,033, filed on Apr. 3, 2017.

(51) Int. Cl. G06Q 50/18; H04L 9/06; H04L 9/32; H04L 9/12

(52) U.S. Cl. CPC G06Q 50/184; H04L 9/0637; H04L 9/3236; H04L 9/3297; H04L 9/12; G06F 16/9024

(57) ABSTRACT

A system and methods for managing intellectual property using a blockchain are provided which may include one or more elements which forms a comprehensive foundation for an eco-system for innovation and intellectual property management. The elements may include: an intellectual property distributed ledger, an intellectual property digital policy server, non-binary trust models, automatic ontology induction, modifications to the blockchain “mining” and “proof of work” system, appstore for related applications, partial transparency transactionalized search engine, persistent and encapsulated software trust objects, licensing royalty smart contract with auditable payment tracking, micro-equity incentives, automated fraud detection intellectual property management dashboards, innovation workflow broker, innovation optimization tools, disruption mapping, and intelligent just-in-time learning. The system combines and integrates these functions to enable personal, intra-enterprise, inter-enterprise and extra-enterprise recordation, collaboration, searchability and its benefits, licensing and tracking of information regarding intellectual property over a networked distributed computing system.

### CROSS REFERENCE TO RELATED APPLICATIONS

This application is a continuation of U.S. application Ser. No. 17/509,801 filed on Oct. 25, 2021, which is a continuation of U.S. application Ser. No. 15/942,988 filed on Apr. 2, 2018, which in turn claims Provisional Application No. 62/481,033, filed on Apr. 3, 2017, entitled “METHODS AND SYSTEM FOR MANAGING INTELLECTUAL PROPERTY USING A BLOCKCHAIN”, all of which are hereby incorporated by reference in their entirety.

### APPENDIX TO THE SPECIFICATION

This application contains an appendix labeled as “Appendix_A”. The entire contents of which are hereby incorporated by reference in their entirety.

### FIELD OF THE INVENTION

The present invention is generally related to systems and methods for processing intellectual property data, rights and transactions. These tools comprise diverse capabilities for data presentation and processing, proof of existence and timestamping, trust relationships, licensing, collaboration and optimization. These systems, methods and processes specifically relate to blockchain technology, which is a computer-implemented method for accessing, developing and maintaining a decentralized database through a peer-to-peer network, to preserve the original state of data input.

### BACKGROUND

Intellectual property has become increasingly more important in today's global economy. Intellectual property can be viewed as a new type of currency in this economy because it is now more easily translatable to value, and vehicles for ownership of that intellectual property such as patents and copyright, can store that value. Accordingly, even in fast-moving industries, intellectual property rights which cover core technology can be very valuable, even for an extended period of time. Intellectual property is also valuable as a revenue generator. In 1993, for example, the revenue generated from patents by U.S. companies was over $60 billion. These patent revenue dollars are increasing every year.

However, the patent process is very expensive and slow moving. In 2009, the United States Patent and Trademark Office had 718,835 applications awaiting their first office action and a total of 6,143 Examiner's available to process these outstanding patent applications. The Average Total Pendency (“Total Pendency” is the total time to process a patent application such that the application is approved and a patent is issued or the application is rejected) time in 2009 was 34.6 months. Furthermore, the patent system is highly litigious. According to the American Intellectual Property Law Association, the cost of an average patent lawsuit, where $1 million to $25 million is at risk, is $1.6 million through the end of discovery and $2.8 million through final disposition. Adding insult to injury, more than 60% of all patent suits are filed by non-practicing entities (NPEs) that manufacture no products and rely on litigation as the principal component of their business model.

If inventors and corporations were able to search a distributed ledger that held a publicly or privately verifiable and unalterable record of all intellectual property claims, including both the content and the structure of that ledger, before developing and releasing new products, they might be able to better avoid costly patent infringement litigation. Often, however, inventors and corporations do not conduct an adequate level of prior art and patent search. One significant reason for this is the difficulty in identifying relevant patents using simple keyword searches, and the difficulty in analyzing them.

Furthermore, patents remain one of the most underutilized assets in a company's portfolio. This is due, at least in significant part, to the fact that patent analysis, whether for purposes of licensing, infringement, enforcement, freedom to operate, technical research, product development, etc., is a very difficult, tedious, time consuming, and expensive task, particularly when performed with paper copies of patents. It would be much more cost and computationally effective to allow artificial intelligence functions to operate over a digital system than a paper based one. There are few automated tools for patent analysis currently available. The software tools that are available cannot, for example, be used to facilitate the analysis and development of business strategies to increase corporate shareholder value through the strategic and tactical use of patents.

Other processes dealing with intellectual property, such as collaboration, tracking, invention disclosures, licensing and payment histories, trust and reputation standings, and managing intellectual property assets, are equally cumbersome. Although software exists in all of these categories, they are limited in functionality, as they in general cannot correlate, analyze, and otherwise process intellectual property-related information effectively. Further, no existing software tool can perform all of these tasks automatically.

Traditional methods of preparing, filing and examining intellectual property documents have been centered around a paper-based methodology. Let us consider the patent application process as an example: patent practitioners and Patent Offices each enter appropriate due dates and save papers they prepare in their internal databases respectively. For example, technology developers save and back up invention disclosure databases; patent practitioners save copies of patent applications and response to office actions; and patent office's save office actions in database. Typically, such due dates are manually entered into a docketing database by docketing clerk or other appropriate personnel.

There are also various communications and exchanges between the inventor and practitioner, between the in-house practitioner and outside practitioner and between a foreign practitioner or agent and prosecuting practitioner or agent. Obtaining protection for a single patent application in multiple countries, i.e., prosecuting the application to issuance and paying necessary annuity and maintenance fees, typically involves over a hundred separate transactions between the applicant or inventor, practitioners and/or patent agents and the various patent offices.

Now consider the processes of searching for or offering technology to license, negotiating licensing agreements, tracking and auditing the royalty payments, defending patents against non-practicing entities, and so forth. These services, however, generally require the services of law firms and certified public accountants and require significant expense. Generally, these services also maintain their own separate database for such docketed due dates and milestones and payments.

The situation is worsening, with inventors around the world filing 2.9 million patent applications in 2015, representing a 7.8% increase over 2014 and the sixth straight year of rising demand for patent protection, according to WIPO's annual World Intellectual Property Indicators report. This number is anticipated to double over the next several years. Tracking all the various due dates, communications and papers associated with such filings can be a tremendous burden.

In addition, as the number of invention disclosures, pending patent applications and issued patents increases, the ability of a technology developer manager to know and understand the contents of the technology developer's intellectual property portfolio decreases. While there are existing databases and other tools for storing intellectual property portfolio information, these databases typically include only bibliographic information regarding patents or patent applications and often require that information be manually entered by the user. Moreover, these database tools are often optimized for a particular purpose, such as docketing or annuity payments, and the various databases optimized for these purposes are often incompatible in data format and manner of usage. These databases and other tools limit the ability of technology developers to know the contents and status of the assets in their intellectual property portfolios and thereby hinder their efforts in obtaining full value from their portfolios.

Furthermore, due to the increasing pace of technology development and an increased emphasis on obtaining full value from their patent portfolios, technology developers are placing more pressure on intellectual property managers to file greater numbers of patent applications. Shortages in trained patent practitioners, patent agents and other patent personnel, however, make it difficult to increase the number of patent applications prepared using current systems. There is therefore an acute need to increase the efficiency of current invention disclosure creation and patent application filing procedures as well as to improve the techniques used to manage intellectual property assets.

Finally, it has been shown that insiders in R&D-intensive industries trade on information that emerges during the patent application process. Recent high-profile prosecutions show that insiders in professional advisory firms do so, as well. We can further assume that some employees in Patent Offices in less technically advanced countries may be tempted to take advantage of the similar (illegal) opportunities. While the Electronic Filing System of the USPTO prevents any unauthorized alteration of filing dates and details, patent offices in less technically advanced countries may tamper with filing dates and/or delay approval in order to cover any tracks they might leave when trading on such inside information. A hallmark of decentralized record keeping based on a blockchain is that any changes to the sensitive information in the patent application immediately becomes apparent. A blockchain could also assist regulatory compliance officers investigating cases of suspected insider trading by providing names and dates of all people who have accessed the patent application.

Accordingly, as can be seen from the above description, improved methods of facilitating the preparation of intellectual property documents, including patent applications, securing intellectual property rights and managing intellectual property assets and licensing, tracking royalty payments, and many other task, are desirable.

### BRIEF SUMMARY OF THE INVENTION

A system and methods for managing intellectual property using a blockchain are provided which may include one or more elements which forms a comprehensive foundation for an eco-system for innovation and intellectual property management. The elements may include: an intellectual property distributed ledger, an intellectual property digital policy server, non-binary trust models, automatic ontology induction, modifications to the blockchain “mining” and “proof of work” system, appstore for related applications, partial transparency transactionalized search engine, persistent and encapsulated software trust objects, licensing royalty smart contracts with auditable payment tracking, the use of micro-equity incentives, automated fraud detection, intellectual property management dashboards, innovation workflow broker, innovation optimization tools, disruption mapping, and intelligent just-in-time learning. The system combines and integrates these functions to enable personal, intra-enterprise, inter-enterprise and extra-enterprise recordation, collaboration, searchability and its benefits, licensing and tracking of information regarding intellectual property over a networked distributed computing system.

According to one embodiment consistent with the principles of the invention, a method for providing a Merkle directed idea graph stored in a blockchain database is provided. In some embodiments, the method may include: receiving a data set describing intellectual property; creating a root node comprising the data set; calculating a hash value for the data set of the root node; storing the hash value of the root node; receiving a commit data set describing changes to the data set describing the intellectual property; calculating a hash value for the commit data set; and storing and linking the commit data set hash to the hash value of the root node as a new branch of the idea graph.

According to another embodiment consistent with the principles of the invention, a method for performing a partial transparency transactionalized search of intellectual property is provided. In some embodiments, the method may include: receiving data having a number of content fields which describe intellectual property; receiving search term(s) for querying received intellectual property; collecting data describing intellectual property having matching search terms; determining which content fields of intellectual property having matching search terms to return to the searcher based on status and reputation of searcher; and providing determined content fields of matching intellectual property to searcher.

According to a further embodiment consistent with the principles of the invention, a method for creating a licensing royalty smart contract with auditable automated payment tracking is provided. In some embodiments, the method may include: storing data describing terms for licensing and royalty requirements for collaboration in a root node of a Merkle directed graph that comprises a data set describing an intellectual property; storing a commit data set describing changes to the data set describing the intellectual property and data describing the user generating the commit data as a child node of the root node in the Merkle directed graph; receiving data describing the achievement of the licensing and royalty requirements of the root node; and storing data describing licensing and royalty payments to the user that provided the commit data set as another child node in the Merkle directed graph.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts an illustrative example of some of the components and computer implemented methods which may be found in a system for managing intellectual property using a blockchain according to various embodiments described herein.

FIG. 2 illustrates a block diagram of another example showing the relationship between an intellectual property (IP) distributed ledger system according to various embodiments herein.

FIG. 3 shows a block diagram illustrating an example of a client device which may be used by the system as described in various embodiments herein.

FIG. 4 depicts a block diagram showing an example of how the non-binary trust system may operate according to various embodiments described herein.

FIG. 5 illustrates a block diagram showing an example of an automatic ontology induction system according to various embodiments described herein.

FIG. 6 shows a block diagram showing how the modification to blockchain mining operates according to various embodiments described herein.

FIG. 7 depicts a block diagram showing an example of how the system may provide an appstore for applications that deal with intellectual property operates according to various embodiments described herein.

FIG. 8 illustrates a block diagram showing an example of a partial transparency transactionalized search workflow according to various embodiments described herein.

FIG. 9 shows a block diagram showing an example of the use of trust objects by a non-binary trust model of the system according to various embodiments described herein.

FIG. 10 depicts a block diagram showing an example workflow which may be performed by the appstore for applications that deal with intellectual property according to various embodiments described herein.

FIG. 11 illustrates a block diagram showing an example workflow of how the system may automatically track equity incentive contracts according to various embodiments described herein.

FIG. 12 shows a block diagram which illustrates how the system protects against fraud and malware, according to various embodiments described herein.

FIG. 13 depicts a diagram illustrating the structure of an exemplary Merkle directed graph according to various embodiments described herein.

FIG. 14 illustrates a flow diagram illustrating an example of how a Merkle directed graph may operate according to various embodiments described herein.

FIG. 15 shows a block diagram showing an example of a server which may be used by the system as described in various embodiments herein.

FIG. 16 depicts a block diagram illustrating an example of a client device which may be used by the system as described in various embodiments herein.

FIG. 17 illustrates a block diagram showing an example method for providing a Merkle directed idea graph stored in a blockchain database according to various embodiments described herein.

FIG. 18 shows a block diagram depicting an example method for performing a partial transparency transactionalized search of intellectual property according to various embodiments described herein.

FIG. 19 depicts a block diagram showing an example method for creating a licensing royalty smart contract with auditable automated payment tracking according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

### Definitions

As used herein, the term “computer” refers to a machine, apparatus, or device that is capable of accepting and performing logic operations from software code. The term “application”, “software”, “software code” or “computer software” refers to any set of instructions operable to cause a computer to perform an operation. Software code may be operated on by a “rules engine” or processor. Thus, the methods and systems of the present invention may be performed by a computer or computing device having a processor based on instructions received by computer applications and software.

The term “electronic device” as used herein is a type of computer comprising circuitry and configured to generally perform functions such as recording audio, photos, videos and handwritten notes; displaying or reproducing audio, photos, videos and handwritten notes; storing, retrieving, or manipulation of electronic data; providing electrical communications and network connectivity; or any other similar function. Non-limiting examples of electronic devices include: personal computers (PCs), workstations, laptops, tablet PCs including the iPad, cell phones including iOS phones made by Apple Inc., Android OS phones, Microsoft OS phones, Blackberry phones, digital music players, digital notepads, digital pens or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, wearable computers such as Apple Watch, other smartwatches, Fitbit, other wearable fitness trackers, Google Glasses, Apple iPads, Anota digital pens and the like.

The term “client device” as used herein is a type of computer or computing device comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of client devices include: personal computers (PCs), workstations, laptops, tablet PCs including the iPad, cell phones including iOS phones made by Apple Inc., Android OS phones, Microsoft OS phones, Blackberry phones, Apple iPads, Anota digital pens, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, tablets, digital pens, wearable computers such as Apple Watch, other smartwatches, Fitbit, other wearable fitness trackers, Google Glasses, and the like.

The term “computer readable medium” as used herein refers to any medium that participates in providing instructions to the processor for execution. A computer readable medium may take many forms, including but not limited to, non-volatile media, volatile media, and transmission media. Non-volatile media includes, for example, optical, magnetic disks, and magneto-optical disks, such as the hard disk or the removable media drive. Volatile media includes dynamic memory, such as the main memory. Transmission media includes coaxial cables, copper wire and fiber optics, including the wires that make up the bus. Transmission media may also take the form of acoustic or light waves, such as those generated during radio wave and infrared data communications.

As used herein the term “data network” or “network” shall mean an infrastructure capable of connecting two or more computers such as client devices either using wires or wirelessly allowing them to transmit and receive data. Non-limiting examples of data networks may include the internet or wireless networks or (i.e. a “wireless network”) which may include Wifi and cellular networks. For example, a network may include a local area network (LAN), a wide area network (WAN) (e.g., the Internet), a mobile relay network, a metropolitan area network (MAN), an ad hoc network, a telephone network (e.g., a Public Switched Telephone Network (PSTN)), a cellular network, a Zigby network, or a voice-over-IP (VoIP) network.

As used herein, the term “database” shall generally mean a digital collection of data or information. The present invention uses novel methods and processes to store, link, and modify information such digital images and videos and user profile information. For the purposes of the present disclosure, a database may be stored on a remote server and accessed by a client device through the internet (i.e., the database is in the cloud) or alternatively in some embodiments the database may be stored on the client device or remote computer itself (i.e., local storage). A “data store” as used herein may contain or comprise a database (i.e. information and data from a database may be recorded into a medium on a data store).

As used herein, the term “blockchain” shall generally mean a distributed database that maintains a continuously growing ledger or list of records, called blocks, secured from tampering and revision using hashes. Every time data may be published to a blockchain database the data may be published as a new block. Each block may include a timestamp and a link to a previous block. Through the use of a peer-to-peer network and a distributed timestamping server, a blockchain database is managed autonomously. Blockchains are an open, distributed ledger that can record transactions between two parties efficiently and in a verifiable and permanent way. Consensus ensures that the shared ledgers are exact copies, and lowers the risk of fraudulent transactions, because tampering may have to occur across many places at exactly the same time. Cryptographic hashes, such as the SHA256 computational algorithm, ensure that any alteration to transaction input results in a different hash value being computed, which indicates potentially compromised transaction input. Digital signatures ensure that transactions originated from senders (signed with private keys) and not imposters. This covers different approaches to the processing including hash trees and hash graphs. At its core, a blockchain system records the chronological order of transactions with all nodes agreeing to the validity of transactions using the chosen consensus model. The result is transactions that are irreversible and agreed to by all members in the network.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New computer-implemented systems and methods for processing intellectual property data, rights and transactions are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

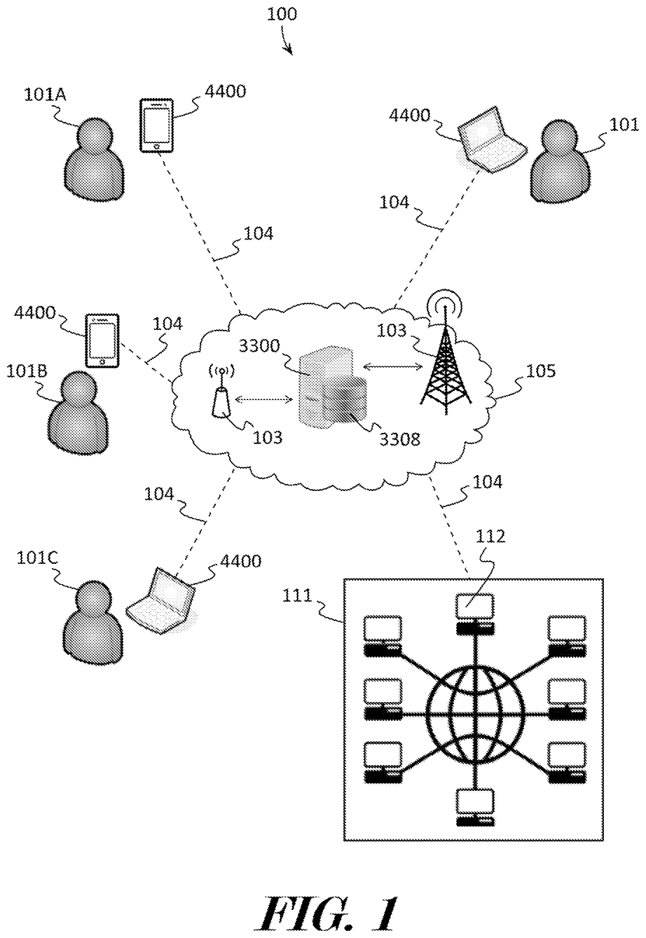

The present invention will now be described by example and through referencing the appended figures representing preferred and alternative embodiments. As perhaps best shown by FIG. 1, an illustrative example of some of the physical components which may comprise a system for managing intellectual property using a blockchain (“the system”) 100 according to some embodiments is presented. The system 100 is configured to facilitate the transfer of data and information between one or more access points 103, client devices 4400, and servers 300 over a data network 105. Each client device 4400 may send data to and receive data from the data network 105 through a network connection 104 with an access point 103. A data store 308 accessible by the server 300 may contain one or more databases. The data may comprise any information pertinent to one or more users 101 input into the system 100 including information on or describing one or more users 101, information on or describing one or more intellectual properties, such as Title, Author, Short abstract, Full content, Fee authorized and Access Policy, information about the inventor, timing of invention, ownership information via a set of transactions, timestamps, licensing and royalty requirements for collaboration, mining reward, and nonce, area of endeavor, background, abstract, brief summary, detailed description, connection of elements, description of variations and alternate embodiments, figures, claims, index, non-disclosure agreements, or any other information which may describe intellectual property and the creators and users of the intellectual property.

In this example, the system 100 comprises at least one client device 4400 (but preferably more than two client devices 4400) configured to be operated by one or more users 101. Client devices 4400 can be mobile devices, such as laptops, tablet computers, personal digital assistants, smart phones, and the like, that are equipped with a wireless network interface capable of sending data to one or more servers 300 with access to one or more data stores 308 over a network 105 such as a wireless local area network (WLAN). Additionally, client devices 4400 can be fixed devices, such as desktops, workstations, and the like, that are equipped with a wireless or wired network interface capable of sending data to one or more servers 300 with access to one or more data stores 308 over a wireless or wired local area network 105. The present invention may be implemented on at least one client device 4400 and/or server 300 programmed to perform one or more of the steps described herein. In some embodiments, more than one client device 4400 and/or server 300 may be used, with each being programmed to carry out one or more steps of a method or process described herein.

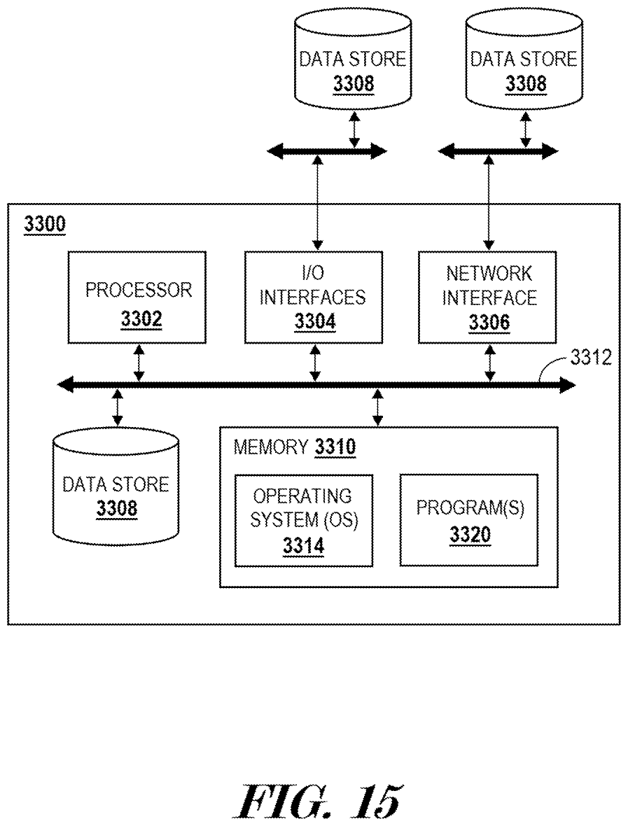

Referring now to FIG. 15, in an exemplary embodiment, a block diagram illustrates a server 3300 of which one or more may be used in the system 100 or standalone and which may be a type of computing platform. The server 3300 may be a digital computer that, in terms of hardware architecture, generally includes a processor 3302, input/output (I/O) interfaces 3304, a network interface 3306, a data store 3308, and memory 3310. It should be appreciated by those of ordinary skill in the art that FIG. 15 depicts the server 3300 in an oversimplified manner, and a practical embodiment may include additional components and suitably configured processing logic to support known or conventional operating features that are not described in detail herein. The components (3302, 3304, 3306, 3308, and 3310) are communicatively coupled via a local interface 3312. The local interface 3312 may be, for example but not limited to, one or more buses or other wired or wireless connections, as is known in the art. The local interface 3312 may have additional elements, which are omitted for simplicity, such as controllers, buffers (caches), drivers, repeaters, and receivers, among many others, to enable communications. Further, the local interface 3312 may include address, control, and/or data connections to enable appropriate communications among the aforementioned components.

The processor 3302 is a hardware device for executing software instructions. The processor 3302 may be any custom made or commercially available processor, a central processing unit (CPU), an auxiliary processor among several processors associated with the server 3300, a semiconductor-based microprocessor (in the form of a microchip or chip set), or generally any device for executing software instructions. When the server 3300 is in operation, the processor 3302 is configured to execute software stored within the memory 3310, to communicate data to and from the memory 3310, and to generally control operations of the server 3300 pursuant to the software instructions. The I/O interfaces 3304 may be used to receive user input from and/or for providing system output to one or more devices or components. User input may be provided via, for example, a keyboard, touch pad, and/or a mouse. System output may be provided via a display device and a printer (not shown). I/O interfaces 3304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 3306 may be used to enable the server 3300 to communicate on a network, such as the Internet, a wide area network (WAN), a local area network (LAN), and the like, etc. The network interface 3306 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 3306 may include address, control, and/or data connections to enable appropriate communications on the network. A data store 3308 may be used to store data. The data store 3308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 3308 may incorporate electronic, magnetic, optical, and/or other types of storage media. In one example, the data store 3308 may be located internal to the server 3300 such as, for example, an internal hard drive connected to the local interface 3312 in the server 3300. Additionally, in another embodiment, the data store 3308 may be located external to the server 3300 such as, for example, an external hard drive connected to the I/O interfaces 3304 (e.g., SCSI or USB connection). In a further embodiment, the data store 3308 may be connected to the server 3300 through a network, such as, for example, a network attached file server.

The memory 3310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 3310 may incorporate electronic, magnetic, optical, and/or other types of storage media. Note that the memory 3310 may have a distributed architecture, where various components are situated remotely from one another, but can be accessed by the processor 3302. The software in memory 3310 may include one or more software programs, each of which includes an ordered listing of executable instructions for implementing logical functions. The software in the memory 3310 includes a suitable operating system (O/S) 3314 and one or more programs 3320. The operating system 3314 essentially controls the execution of other computer programs, such as the one or more programs 3320, and provides scheduling, input-output control, file and data management, memory management, and communication control and related services. The one or more programs 3320 may be configured to implement the various processes, algorithms, methods, techniques, etc. described herein.

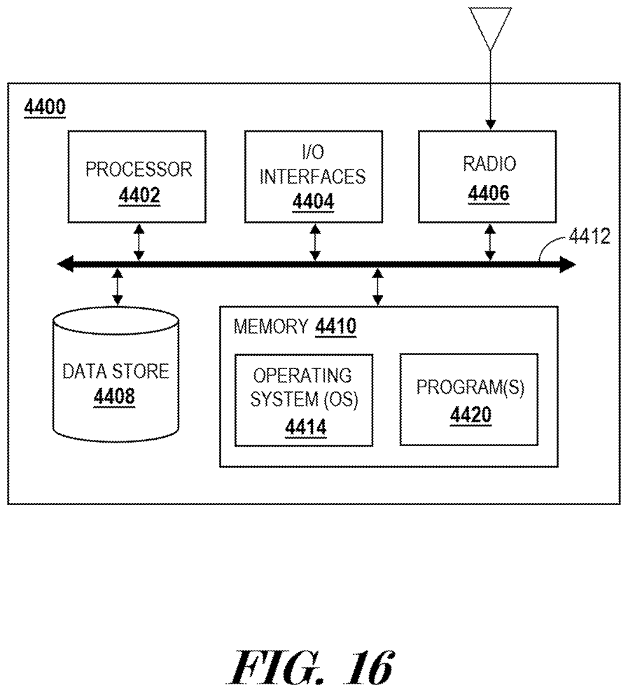

Referring to FIG. 16, in an exemplary embodiment, a block diagram illustrates a client device 4400, which may be used in the system 100 or the like. The term “client device” as used herein is a type of electronic device comprising circuitry and configured to generally perform functions such as recording audio, photos, and videos; displaying or reproducing audio, photos, and videos; storing, retrieving, or manipulation of electronic data; providing electrical communications and network connectivity; or any other similar function. The client device 4400 can be a digital device that, in terms of hardware architecture, generally includes a processor 4402, input/output (I/O) interfaces 4404, a radio 4406, a data store 4408, and memory 4410. It should be appreciated by those of ordinary skill in the art that FIG. 16 depicts the client device 4400 in an oversimplified manner, and a practical embodiment may include additional components and suitably configured processing logic to support known or conventional operating features that are not described in detail herein. The components (4402, 4404, 4406, 4408, and 4410) are communicatively coupled via a local interface 4412. The local interface 4412 can be, for example but not limited to, one or more buses or other wired or wireless connections, as is known in the art. The local interface 4412 can have additional elements, which are omitted for simplicity, such as controllers, buffers (caches), drivers, repeaters, and receivers, among many others, to enable communications. Further, the local interface 4412 may include address, control, and/or data connections to enable appropriate communications among the aforementioned components.

The processor 4402 is a hardware device for executing software instructions. The processor 4402 can be any custom made or commercially available processor, a central processing unit (CPU), an auxiliary processor among several processors associated with the client device 4400, a semiconductor-based microprocessor (in the form of a microchip or chip set), or generally any device for executing software instructions. When the client device 4400 is in operation, the processor 4402 is configured to execute software stored within the memory 4410, to communicate data to and from the memory 4410, and to generally control operations of the client device 4400 pursuant to the software instructions. In an exemplary embodiment, the processor 4402 may include a mobile optimized processor such as optimized for power consumption and mobile applications. The I/O interfaces 4404 can be used to receive user input from and/or for providing system output. User input can be provided via, for example, a keypad, a touch screen, a scroll ball, a scroll bar, buttons, bar code scanner, and the like. System output can be provided via a display device such as a liquid crystal display (LCD), touch screen, and the like. The I/O interfaces 4404 can also include, for example, a serial port, a parallel port, a small computer system interface (SCSI), an infrared (IR) interface, a radio frequency (RF) interface, a universal serial bus (USB) interface, and the like. The I/O interfaces 4404 can include a graphical user interface (GUI) that enables a user to interact with the client device 4400. Additionally, the I/O interfaces 4404 may further include an imaging device, i.e. camera, video camera, etc.

The radio 4406 enables wireless communication to an external access device or network. Any number of suitable wireless data communication protocols, techniques, or methodologies can be supported by the radio 4406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 4408 may be used to store data. The data store 4408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 4408 may incorporate electronic, magnetic, optical, and/or other types of storage media.

The memory 4410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 4410 may incorporate electronic, magnetic, optical, and/or other types of storage media. Note that the memory 4410 may have a distributed architecture, where various components are situated remotely from one another, but can be accessed by the processor 4402. The software in memory 4410 can include one or more software programs, each of which includes an ordered listing of executable instructions for implementing logical functions. In the example of FIG. 16, the software in the memory 4410 includes a suitable operating system (O/S) 4414 and programs 4416. The operating system 4414 essentially controls the execution of other computer programs, and provides scheduling, input-output control, file and data management, memory management, and communication control and related services.

The programs 4420 may include various applications, add-ons, etc. configured to provide end user functionality with the client device 4400. For example, exemplary programs 4420 may include, but not limited to, a web browser, social networking applications, streaming media applications, games, mapping and location applications, electronic mail applications, financial applications, and the like. In a typical example, an end user 101 typically uses one or more of the programs 4420 along with a network 105 to manipulate information of the system 100.

Returning to FIG. 1, in some embodiments, the system 100 may include a blockchain network 111, having one or more nodes 112, which may be in communication with one or more servers 300, and/or client devices 4400 of the system 100. A node 112 may be a server 300, a client device 4400, or any other suitable networked computing platform. The blockchain network 111 may manage a distributed blockchain database 113 containing data recorded by the system 100. This data may be maintained as a continuously growing ledger or listing, which may be referred to as blocks, secured from tampering and revision. Each block includes a timestamp and a link to a previous block. Through the use of a peer-to-peer blockchain network 111 and a distributed timestamping server 300, an IP Ledger blockchain database 109 may be managed autonomously. Consensus ensures that the shared ledgers are exact copies, and lowers the risk of fraudulent transactions, because tampering may have to occur across many places at exactly the same time. Cryptographic hashes, such as the SHA256 computational algorithm, ensure that any alteration to transaction data input results in a different hash value being computed, which indicates potentially compromised transaction input. Digital signatures ensure that data entry transactions (data added to the IP Ledger blockchain database 109) originated from senders (signed with private keys) and not imposters. At its core, an IP Ledger blockchain database 109 may record the chronological order of data entry transactions with all nodes 112 agreeing to the validity of entry transactions using the chosen consensus model. The result is data entry transactions that are irreversible and agreed to by all members in the blockchain network 111.

The blockchain network 111 may comprise a cryptocurrency or digital asset designed to work as a medium of exchange that uses cryptography to secure its transactions, to control the creation of additional units, and to verify the transfer of assets. Example cryptocurrencies include Bitcoin, Ethereum, Ripple, etc. The blockchain network 111 may also comprise tokens common to cryptocurrency based blockchain networks 111. The tokens may serve as a reward or incentive to nodes 112 for blockchain network 111 services and to make the blockchain network 111 attach resistant. The blockchain network 111 may comprise token governance rulesets based on crypto economic incentive mechanisms that determine under which circumstances blockchain network 111 transactions are validated and new blocks are created. Tokens may include usage tokens, work tokens, Intrinsic, Native or Built-in tokens, application token, asset-backed tokens, or any other type of token which may be used in a cryptocurrency network.

The system 100 may be configured to perform and facilitate the recordation, collaboration, licensing and tracking of information regarding intellectual property, which includes intellectual property declarations, recordings, filings, prosecution, licensing transactions and payments, tracking and reputation management. In preferred embodiments, the system 100 may be a global system of record for digitally empowered ideation and intellectual property. For convenience, the system 100 is described below in a manner that highlights the filing, prosecuting and managing patent applications. It should be apparent that the present invention is not restricted to patent cases and could be applied to processes beyond patent applications, and to other forms of property and asset management, including formative ideas, expressions of ideas, trademarks and copyrights. Accordingly, the description of the present invention set forth below is not intended to limit the scope of the present invention in any way. One of ordinary skill in the art may recognize variations, modifications, and alternatives.

FIG. 1 provides a diagram showing the relationship between elements of the system 100 and participants or users 101 of the system 100. Users 101 may include idea designers and technology developers, patent law firms, service providers, patent offices, and potential licensees, producers, directors, writers, or any other person or entity that may work with intellectual property. The system 100 may provide a network-enabled electronic platform that can be utilized by all participants in the intellectual property management process. The system 100 eliminates the need for current paper-based patent prosecution systems and provides an electronic workflow pipeline, allowing every step in the process to be executed electronically, reducing administrative costs and processing time for invention disclosures, patent applications, script disclosures, song disclosures, collaboration formation, and licensing transactions.

The system 100 provides users 101, such as intellectual property professions, owners, and creators, a highly secure, central data repository that can be shared between participants on an as-allowed basis. Information generated and used in the process can be shared between users 101 in order to create patent filings, prosecute such filings, invention disclosures, patent applications, script disclosures, song, disclosures, literary disclosures, collaboration formation and licensing transactions. The system 100 may further be configured to: enable a number of types of intellectual property related processes are promoted to completion; provide an underlying intelligence system gathers metrics about these processes and provides both workflow support to improve the quality and speed of collaboration within and between groups or enterprises and analysis these metrics to provide data for system optimizations; and enable these metrics to be tracked and displayed in graphic dashboards and through a workflow tracking system. This allows the management of an enterprise or an eco-system for track, visualize and optimize innovation process within the system they are tasked to manage.

The system 100 may include an IP Ledger blockchain database 109 configured as a distributed ledger comprising or comprised of an unalterable and persistent semi-public linear data container space with a data schema for both information about intellectual property and patent and meta-information about ideas and innovation which tracks the entire lifecycle of an idea and enables innovation collaboration. The IP Ledger blockchain database 109 stores data using a special schema for both information and meta-information about intellectual property, based on an underlying taxonomy of innovation and ideation.

In preferred embodiments, the system 100 may include one or more computer processors and/or client devices 4400 which may be configured by machine-readable instructions for providing services to a plurality of entities (users 101) through a network 105 which may comprise: at least one distributed ledger subsystem configured to manage intellectual property information associated with the plurality of entities (IP Ledger blockchain database 109), using a Merkle directed acyclic graph 120; at least one digital policy server 3300 configured to manage intellectual property policies associated with a plurality of entities and integrated into the functionality of the Merkle directed acyclic graph 120; at least one trust validation subsystem configured to authenticate the reputation among the plurality of entities based on predefined rules; and at least one broker subsystem configured to authenticate the workflow among the plurality of entities based on predefined rules; and at least one accounting subsystem configured to authenticate the smart contract transactions among the plurality of entities based on predefined rules; a network manager server 3300 configured to communicate with one or more of the at least one intellectual property distributed ledger subsystem 109, one or more of the at least one digital policy server subsystem 3300, one or more of the at least one trust validation subsystem, one or more of the at least one workflow broker subsystem, the at least one geographical location subsystem, the at least one smart contract accounting subsystem and the plurality of entities to provide the services.

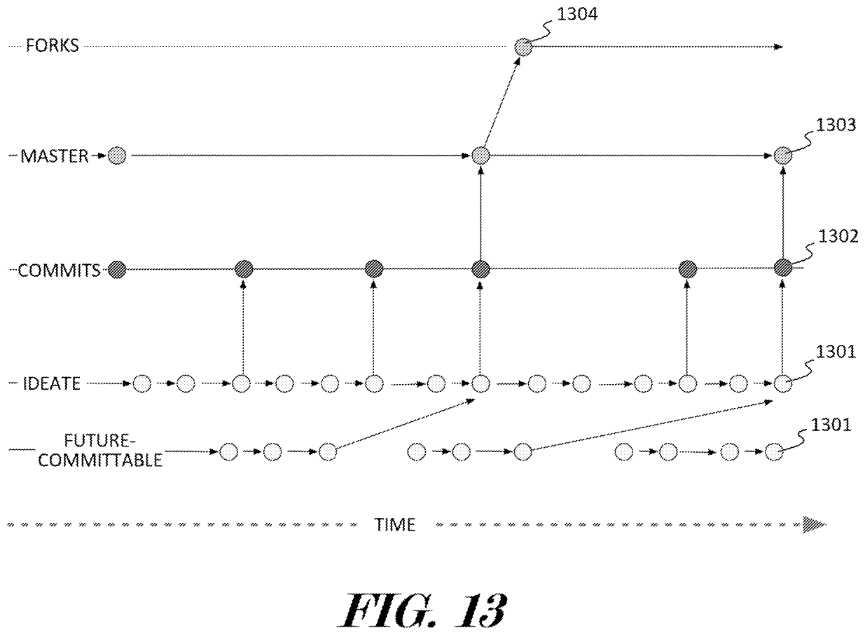

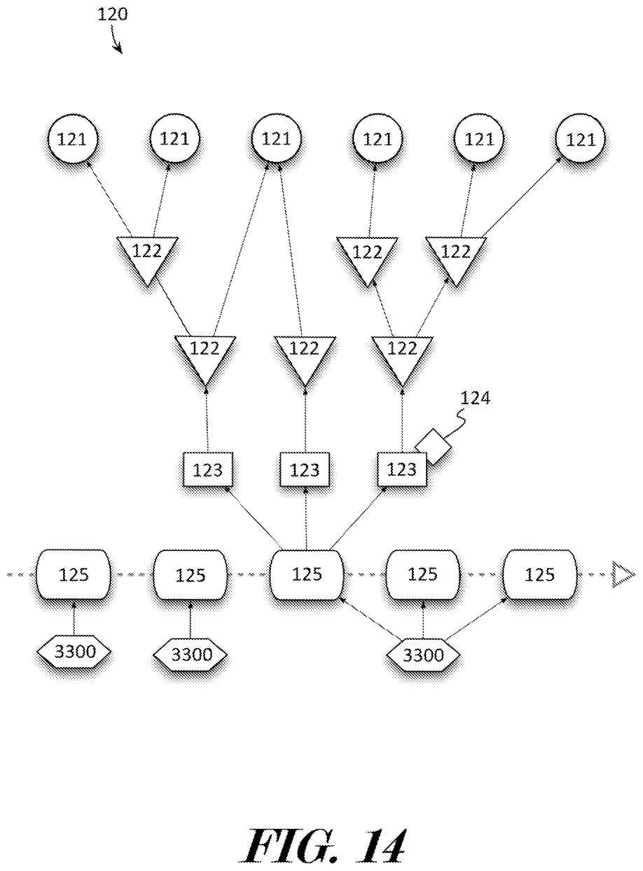

Referring also to FIGS. 13 and 14, in some embodiments, the system 100 may comprise intellectual property descriptions stored in an IP Ledger blockchain database 109 and the system 100 may comprise a Merkle directed graph 120, optionally cyclic and/or acyclic, to capture the evolution of an idea over time and so multiple parties can access the idea, providing an official time stamped global system of record (SOR) for ideas. This enables the tracking of the entire lifecycle of an idea and enables greater collaboration between multiple parties. A BLOB 121 is a Binary Large Object, a collection of binary data stored as a single entity in a database management system. A tree 122, according to mathematical graph theory, is an undirected graph in which any two vertices are connected by exactly one path. In other words, any acyclic connected graph is a tree 122. A commit 123 may comprise an individual change to a file or set of files. Every commit 123 creates a unique ID (a.k.a. the “SHA” or “hash”) that allows you to keep record of what changes were made when and by who. A tag 124 may comprise a keyword or term assigned to a piece of information, also known as metadata, that helps describe an item and allows it to be found again by browsing or searching. Preferably, a tag 124 may mark a specific point in history as being important. An idea 125 may be defined to be a plan, a suggestion, or a possible course of action to develop a product, service, process or organizational model. An IP Policy Server 3300 may comprise a network application that manages the secure discovery, selection, collaboration, authentication and automation of legal agreements to protect, manage and license intellectual property.

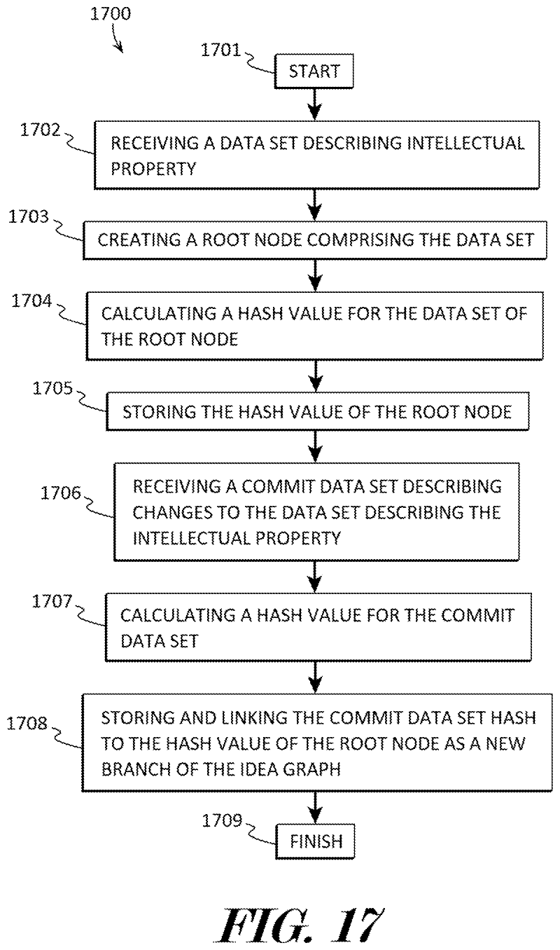

Referring also to FIG. 17 and in preferred embodiments, the system 100 may provide a method for providing a Merkle directed idea graph stored in a blockchain database (“the method 1700”). The method may start 1701 and a data set having a number of content fields which describe intellectual property may be received in step 1702 from a user 101 that may be an intellectual property creator via their client device 4400. The data set may have content which may include Title, Author, Short abstract, Full content, Fee authorized and Access Policy, information about the inventor, timing of invention, ownership information via a set of transactions, timestamps, licensing and royalty requirements for collaboration, mining reward, and nonce.

In step 1703, the system 100 may create a root node comprising the data set. Preferably, the root node may be created in a Merkle directed graph 120 which may be stored in an IP Ledger blockchain database 109 or other database of the system 100.

In step 1704, the system 100 may create or calculate a hash value for the data set of the root node. Any suitable cryptographic hash function may be used, such as the SHA256 computational algorithm.

In step 1705, the system 100 may store the hash value of the root node. In preferred embodiments, the hash value may be stored in a cyclic or acyclic Merkle Directed Graph 120 to form a “hash tree”, in which every leaf node is labeled with the hash of a data block and every non-leaf node is labeled with the cryptographic hash of the labels of its child nodes.

In step 1706, the system 100 may receive a commit data set 123 describing changes to the data set that describes the intellectual property from the client device 4400 of a user 101.

In step 1707, the system 100 may create or calculate a hash value for the commit data set via the cryptographic hash function used in step 1704.

In step 1708, the system 100 may store the hash value obtained in step 1706 and link the commit data set hash to the hash value of the root node as a new branch of the idea graph as a child node of the node created in step 1705 of the Merkle Directed Graph 120. After step 1708, the method 1700 may end 1709.

In preferred embodiments, a cyclic Merkle directed graph 120 may be used to manage the process of merging ideas. Instead of implementing the core IP Blockchain ledger 109 as a simple linear record of ideas with records that define its ownership and description, it may be configured as a directed cyclic graph to capture the evolution of an innovation or a living idea over time, while providing multiple parties access to the idea within a digitally expressed dynamic licensing and collaboration agreement. Merkle trees are used in many kinds of verification, for example, in “git” software repositories and Bitcoin.

In preferred embodiments, the system 100 may enable one or more functions associated with a directed idea graph which may include: creating an idea graph root node, adding the genesis invention disclosure and establishing the project; making a change or update to an idea graph; validating that an idea graph, or some component of it, is a valid branch of that tree and has not been modified; and forking or merging branches of the tree. The idea graph uses local and remote repositories that can be synchronized and allows for requests for synchronization and approval.

In some embodiments, to create an idea graph root node, the inventor may first create a local repository having data which may be equivalent to an inventor's notebook. The repository may also include information about the inventor, timing of invention, ownership information via a set of transactions, timestamps, licensing and royalty requirements for collaboration, mining reward, and nonce. This would be a root node of an idea graph.

Next, the inventor may create add the text files that describe the invention or other intellectual property work, such as image and video files that illustrate it, chat and messaging files that provide evidence of collaboration. Adding the files puts them under source control and revision tracking, with internal timestamps. The inventor may make changes or add content that is tracked by the system. The commit data sets 1302 may be added to the IP Ledger blockchain database 109. Users 101 may tag commit data sets 1302 as patent prosecutable or otherwise actionable to create prosecutable data sets 1303. Users 101 may tag prosecutable data sets 1303 as new ideas to branch a prosecutable data set 1303 into a new idea data set 1304.

Next, the inventor may make an initial commitment to a remote repository, taking all the files and associated information, creates a hash, uploads all the files to a decentralized persistent storage system, and contacts a remote idea graph repository to request synchronization. The local and remote repositories maintain the structure of the “tree of hashes”, known as a Merkle tree. However, this implementation of the tree uses a cyclic, rather than acyclic, as is normally done. The address of the remote repository could be an http:, ssh: or dig: address. However, it should be noted that this is “content addressing” and not “host addressing”, in that the hash generated serves as the locator of the content and invention file.

In some embodiments, in order to update or make a change to a Merkle directed idea graph 120, the inventor may make changes to the local repository by creating a commit data set 1302, make a “commit” to the source control system, and then synchronize the changes to the persistent decentralized file storage and remote idea graph repository. Next, the commit process takes the changes, creates a hash, and adds it as a new branch of the idea graph. In some embodiments, to validate that a Merkle directed idea graph 120, or some component of it, is a valid branch of the tree and has not been modified, the system can perform a Merkle proof that validates branches of the tree incrementally to determine if a branch has been modified, making it a computationally inexpensive process.

In some embodiments, to participate in the development of an idea graph, a third-party collaborator may first request membership in the group to be authorized to make changes to the Merkle directed idea graph 120. The membership application may then be analyzed manually or automatically, based on the digital reputation score of the requestor. Additionally, the proposed royalty or licensing share could be adjusted based on a reputation score for that user. Once authorized, the user can make a copy of the files into a local repository, and make changes to it, make a “commit” to the source control system, and then request synchronization of the changes, which is under the control of the inventor. This commit takes the changes, creates a hash, and adds it as a new branch of the Merkle directed idea graph 120.

While there have been numerous analyses of how reputation may be computed and managed, there has to date been no systematic approach for implementing reputation systems, nor strategies for self-optimizing reputation management, proposed for decentralized networks. However, the system 100 utilizes both transactional and non-transactional trust data. Transactional data includes a record of failed vs successful transactions, such as the history of successful vs unsuccessful transactions at eBay. Non-transactional data includes trust primitives such as verified claims, as well as indeterminate trust assertions.

Preferably, a self-optimizing reputation framework needs to use adaptively weighted voting to assess trust and reputation. In some embodiments of the system 100, reputation may be defined to be a convolution of transactional and non-transactional data, with associated weighting based on the trustability of the rater. For purely transactional data, the weighting would be stronger, and for indeterminate trust assertions, the weighting would be weaker.

Each piece of trust data may comprise a vector with two attributes: (i) the probability of successful transaction, (ii) size/scope of trust area—which can be weighted by the trustability of the data source. The system 100 may collect all of the available data, in order to gauge the width of the distribution to get a sense of the confidence in that reputation score. Thus, a “trust object” can be described by the equation:

T_{O}=f(P̅,S̅), (1)

where T_{O} is a trust datum, P is the estimated probability of successful transaction according to this source, S is the size/scope of trust area, and T is the trustability of the data source.

And so, the reputation of users 101 of the system 100 may be a convolution of that trust data, weighted by the trustability of that data source as shown by the equation:

Rᵤ=g(T₁×PR_{Ru1},T₂×PR_{Ru2} . . . Tₙ×PR_{RuN}), (2)

where reputation of user “u” is Ru, where Ru is a function “g” of the trust datum of each data object times the probability prediction of ‘u’ of that trust object—‘PR_{Ru1}’, for each of the trust objects.

This provides a multi-dimensional vector that defines the probability of a successful transaction over a range of transaction sizes and scope, along with a confidence factor for the type of trust data offered. Therefore, a counterparty may use that vector, estimate the risk for their particular scope or size of transaction, and include reputation as a way to weigh which vendor or contractor to use.

Furthermore, it should be noted that a reputation or track record should evolve and improve over time. Thus, the system 100 may collect an extensive history of such votes and contributions to capture the time varying effects of such performance, rather than a point estimate, like a credit score.

An adaptive weighting strategy may be used to continuously refine and adjust weights which are just as important as the underlying transactional data. Also, the system 100 may look for a reciprocity or retaliation pattern detector, in order to filter out such effects as the social reluctance to give negative feedback.

Furthermore, these trust values should be automatically normalized. For example, if a particular voter tends to be a “hard grader”, the system 100 may normalize to correct this bias, so that the impact such hard graders or scam graders, like on Yelp, can be mitigated.

Finally, the system 100 may maintain all of these reputation scores as discrete distributions (DPDs) so that the confidence in a certain reputation score can be accurately assessed with greater speed at any time.

In some embodiments, to fork or merge branches of the tree, a third-party collaborator may be required to be an authorized member if the group collaborating on the idea. If the user believes that a variation in the use or process makes the new branch significantly different and only ancillary to the original invention, they can make changes to the local repository that define the variation, and request to fork the tree to establish a new root node, with a reduced licensing fee. This reduced fee could be manually or automatically managed. If the user believes that the combination of two separate idea tree creates an invention that is significantly different and only ancillary to the original inventions, they can make changes to the local repositories that define the variation, and request to merge the trees to establish a new root node, with a reduced licensing fee that is divided by the two root node trees. This reduced fee could be manually or automatically managed. These actions result in the system 100 creating a hash, and the system 100 adds it as a new branch of the Merkle directed idea graph 120.

Furthermore, the use of a Merkle directed cyclic graph 120 can enable the formation of dynamic patent pools to organize complex discoveries and to resist attacks by non-practicing entities and simplify licensing by making IP rights available from standard rates, reducing IP risks and licensing costs. Using distributed ledgers to record all licensing payments in fulfillment of these licensing agreements would further reduce risks, and potentially stimulate greater and earlier investment in product development.

In preferred embodiments, the Merkle directed idea graph 120 enables the formation of virtual open laboratories, where researchers may collaborate with fewer constraints of confidentiality. This enables limiting the access to certain information to putative collaborators with sufficient clearance based on reputation. In addition, certified yet shielded records of inventive efforts could potentially answer the U.S. patent system's incentive to disclose early (‘First-Inventor-to-File’, allowing for a 1-year ‘grace period’ after disclosure), while not compromising prior art requirements of ‘First-to-File’ systems, effectively bridging USPTO and EPO jurisdictions. With multiple credible contributors accessing and building on research findings and ideas, the idea graph promises to accelerate, simplify, and defragment research, which in turn defragments IP landscapes.

Acyclical means the branches of the tree never touch, cyclical means they can rejoin later. A connected acyclic graph is known as a tree 122, and a possibly disconnected acyclic graph is known as a forest. A Merkle Directed Acyclic Graph is basically a “hash tree”, in which every leaf node is labeled with the hash of a data block and every non-leaf node is labeled with the cryptographic hash of the labels of its child nodes. Further, a Merkle tree can be binary, as it is in github, or non-binary, as it is in Ethereum. By definition, hash values are stored in a Merkle tree. They are used only to verify integrity in a computationally inexpensive manner. Data in a Merkle tree can be audited using only the root hash in logarithmic time to the number of leaves (this is also known as a Merkle-Proof). The “Merkleness” of a tree implies that we are using cryptographic hashes. The idea graph would thus be an implementation of a Merkle tree, in that it uses a directed graph and hashes. The hashes only verify authenticity and timestamp of the data, the information about the genesis and evolution of the idea itself is captured in primarily in the content captured and hashed in the tree. However, the structure of the tree itself could provide some insights via metadata about process of refinement, who contributed more ideas, when things were conceived.

The example Merkle directed graph 120 of FIG. 14 is acyclical, because it represents the vast majority of the use of the idea graph, to manage an idea and its refinement. However, in a small number of instances, it will be possible to merge two branches, from either the same root node or different ones. Merging two branches from the same root node indicates that a significant diversion from the main concepts was proven to be equivalent and the root ideation lineages are merged back. Merging two branches from the different root nodes indicates that the combination of two ideas is creating something new and different and only related to their antecedents in an ancillary way.

In preferred embodiments, the system 100 may use the reputation score to allow or not allow changes of a requesting user 101 to be made. The system 100 may comprise a trust score for each user 101, and a minimum level threshold of trust could automatically allow a user 101 to join a group refining an idea. For example, if the trust score is [0,800] (with 800 being very trustable) then a minimum score of 700 could be used as the threshold. However, the system 100 may require greater resolution per our “size/scope of trust area” requirement. Hence, as another example, an eBay vendor with a good reputation selling products for less than $100, would not have as good a reputation for a $100,000 transaction.

Furthermore, system 100 enables an easier and more secure method for finding and interlinking collaboration partners, to allow multiple enterprises to interoperate through computer supported licensing, partnerships and collaborations about ideas and innovation, and allows applications to operate across the normal digital boundaries of enterprises. In preferred embodiments, the system 100 uses one or more client device 4400 configured as dynamically generated communications workspaces to capture collaborative input, cognizant of the need for confidentiality of intellectual property, and allows the collaboration team to refine and evaluate work in progress using heuristic formulae for optimized collaboration and decision-making, while the underlying computing system provides workflow monitoring and analytics for management to track progress.

In some embodiments, client devices 4400 of the system 100 may use a graphical user interface that enables the display and analysis of metrics related to the nature, content and velocity of ideation and collaboration, on each of a number of networked client devices 4400.

In some embodiments, the system 100 may include a multi-company marketplace innovation forum, having non-binary trust models and managed partial transparency, enabling trustable blind searches and matchmaking that may allow companies to more effectively and securely seek and locate partnerships around valuable intellectual property with less effort managing confidentiality.

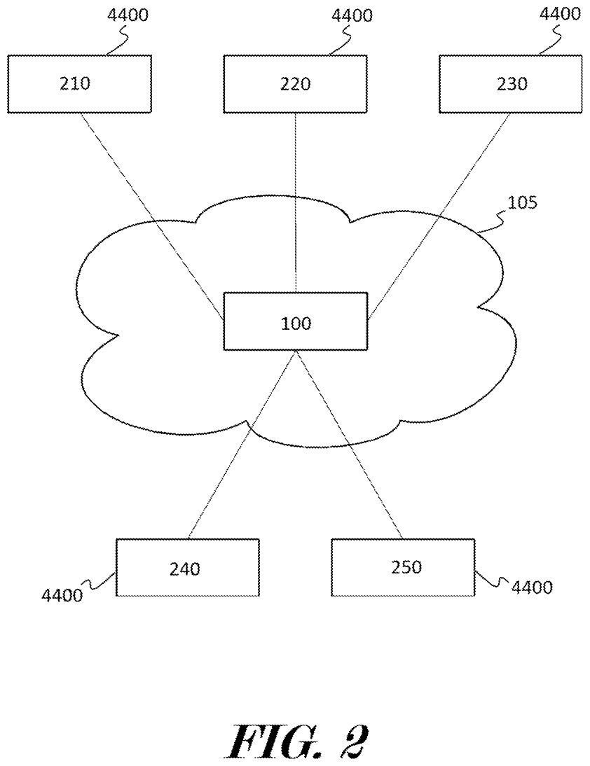

FIG. 2 is a block diagram showing an example of the relationship between an intellectual property (IP) distributed ledger system according to an embodiment of the present invention and other components of the architecture and other participants in the system 100. The participants shown in FIG. 2 include idea designers and technology developers 210, patent law firms 220, service providers 230, patent offices 240, and potential licensees 250, and communication may be via their respective client devices 4400 over a data network 105. Some specific functions provided by the system 100 may include: online creation of invention disclosures, witnessing, archiving and secure sharing of invention disclosures between technology developers and patent counsel; integration of patent claim trees and patent-trademark relationship trees within the data structure of the intellectual property distributed ledger system; automated conversion of invention disclosures into patent applications and automated electronic filing of such applications with patent offices; electronic filing and prosecution of patent applications in patent and offices worldwide, allowing all correspondence to and from patent offices to be paperless and with automated assurances of delivery and timely response; automated docketing by participating patent offices in a standardized database accessible to all authorized participants, electronic notification of due dates and electronic payment of annuity fees; semi-automated docketing by third party agents to service non-participating patent offices; online receipt and examination of patent applications and issuance of office actions by patent offices worldwide; and coordinating, tracking and providing payment options for all financial aspects of the patent process including patent office fees, practitioner fees and service provider fees. Although certain aspects of the system 100 are described herein within the exemplary context of the patent prosecution environment, it is to be appreciated that the invention is not so limited, and that aspects of the present invention are applicable in any type of intellectual property rights management environment or idea management environment. The system 100 combines and integrates these functions to enable personal, intra-enterprise, searchability and its benefits, collaboration, licensing and tracking of information regarding intellectual property or ideas over a networked distributed computing system.

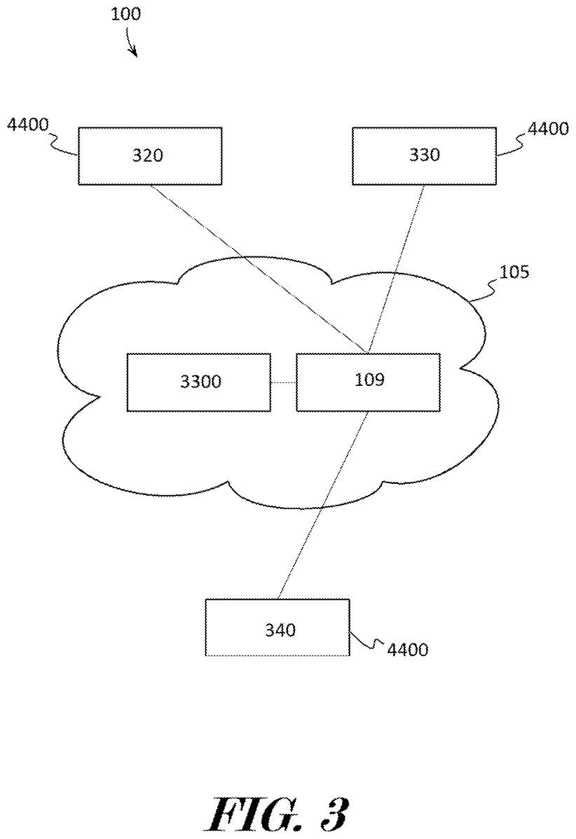

FIG. 3 is a block diagram of another example showing the relationship between an intellectual property (IP) distributed ledger system 100 according to an embodiment of the present invention and other components of the architecture and other participants in the system 100. The participants shown in FIG. 3 include an intellectual property policy server 3300, IP Ledger blockchain database 109 (intellectual property distributed ledger), the inventor/user 320, patent offices 330, and potential licensees 340. Communication may be enabled through the respective client devices 4400 which may be in communication via a data network 105. The system 100 may include one or more digital policy servers 3300, which provides for the digital execution of standardized legal agreements for intellectual property, including non-disclosure, confidentiality, licensing, partnering and compensation agreements, and which manages the process by which intellectual property is electronically secured, shared or licensed, and insures that confidential information is not divulged inappropriately. Preferably, the digital policy server 3300 may do so by facilitating the execution of digital confidentiality agreements, licensing smart contracts, and fine resolution entitlement in an intelligent and automated manner. The legal cost and overhead for intellectual property management is quite significant, and the automation of such services will significantly reduce costs and will enable the management of a portfolio or matrix of collaborations in a multi-enterprise innovation environment. Additionally, the IP digital policy server 3300 enables automated confidentiality and non-disclosure agreements and digitally executes smart contracts for intellectual property to implement how the information will be secured, shared, collaborated and compensated.

As an example, without limitation, a digital policy server 3300 or other component of the system 100 may dynamically codify various levels of strength for confidentiality agreement, or make the mutual, or agree on jurisdiction, termination and other terms. Each of these terms may be encoded in a manner that is both human and machine readable, so that smart contract automated execution of certain terms is possible. In further embodiments, a digital policy server 3300 or other component of the system 100 may provide a graphical view of the various legal agreements that a user has agreed to. In alternative embodiments, a digital policy server 3300 or other component of the system 100 may be configured to allow a user 101 to author, offer or sell extensions in a manner that are understandable by the system's “smart contract” technology.

In the field of computer security, general access control includes authorization, authentication, access approval, and audit. Accordingly, the system 100 enables each of these four functions through novel approaches. Access approval, whereby a computing system makes a decision to grant or reject an access request from an already authenticated subject, is normally based on what the subject is authorized to access. However, using the system 100 access is based on both the what the requestor user 101 is authorized to access and the trust level of the requestor user 101 and the current contractual relationship between the requestee user 101 and requestor user 101. Access is approved based on successful authentication and/or based on an anonymous access token. Authentication methods and tokens may include passwords, biometric scans, physical keys, electronic keys and devices, hidden paths, social barriers, trust levels, and monitoring by humans and automated systems. Auditing information for the access to information may be recorded in the IP Ledger blockchain database 109 (intellectual property distributed ledger).

In further embodiments, some specific functions provided by an intellectual property policy server 3300 may include: initiating, coordinating and tracking of non-disclosure, partnering and licensing agreements between parties within an innovation eco-system, which is a group of linked but separate entities that are sharing ideas and information because they are working in related domains of knowledge and can each benefit from sharing the resulting learning that occurs; facilitating intelligent, fine resolution entitlement capability to insure that confidential information is not divulged inappropriately in an electronic innovation collaboration platform; the extension of internally-focused corporate innovation platforms toward open yet secure innovation platforms; fostering greater collaboration within an innovation eco-system by simplifying processes for sharing ideas and information while retaining appropriate confidentiality by enabling partial disclosure of only the requisite information; increasing licensing of technologies from academia to industry; improving communications of user 101 needs back to the inventor; enabling automated data collection for the study of cross-organizational collaboration; and enabling an open “appstore” approach to easily creating compatible extensions to the intellectual property policy server.

In this manner, the system 100 enables a number of types of collaboration processes to be promoted to completion, and metrics may be tracked and displayed in graphic dashboards and through a workflow tracking system. The system 100 combines and integrates these functions to enable a new kind of innovation framework which enables client devices 4400 to be configured as digital innovation hubs that are able to transform current corporate innovation processes.

Non-Binary Trust Model

In some embodiments, the system 100 may include a non-binary trust model which allows for more accurate measures and assessments of trustability, which can be shared over distributed business and social networks, and uses this as a basis for recording trust level on a distributed ledger and in the operation of access models to confidential information. In general, access control systems depend on authentication rather than trust. In this system 100, authentication is the baseline, and access depends on the level of trust between the parties. Like a credit card transaction, the system 100 includes active and adaptive fraud detection and trust scoring to allow or deny access to confidential information.

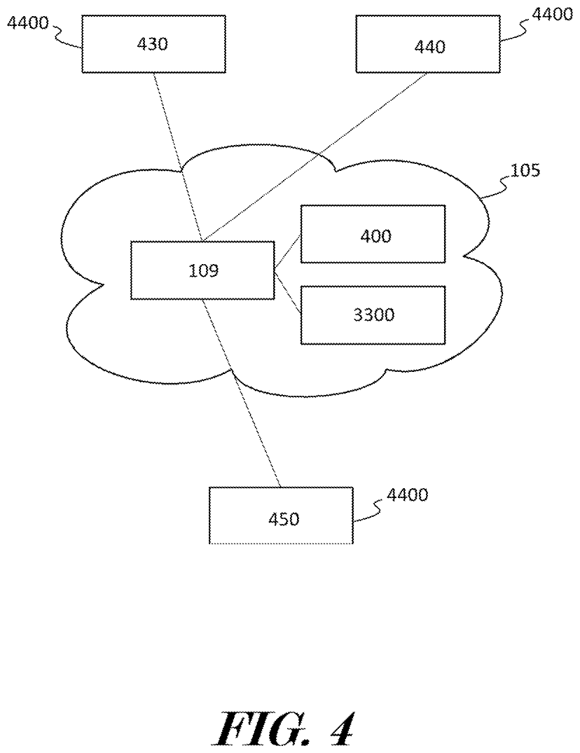

FIG. 4 is a block diagram showing an example of how the non-binary trust system may operate according to an embodiment of the present invention and other components of the architecture and other participants in the system 100. The participants shown in FIG. 4 include the computing device operating the non-binary trust system logic 400, intellectual property contained in a IP Ledger blockchain database 109, intellectual property policies in a digital policy server 3300, the inventor/user 430, patent offices 440, and potential licensees 450. Communication may be provided through client devices 4400 in communication with a data network 105.

In some embodiments, functions provided by the non-binary trust system logic 400 may include: informing decisions in the search for potential partnerships within an innovation eco-system; facilitating partnering agreements between parties within an innovation eco-system; and facilitating intelligent, fine resolution entitlement capability to ensure that confidential information is not divulged inappropriately in an innovation platform. The system 100 combines and integrates these functions to enable a kind of new innovation framework which enables client devices 4400 to be configured as digital innovation platforms or “hubs” that may further transform current corporate innovation processes.

Automatic Ontology Induction

In some embodiments, the system 100 may include an automatic ontology induction system 500 which may automatically organize the data by grouping into different clusters or classifications 503 to perform more effective search of the dataset. In the exemplary context, the automatic ontology induction system 500 provides the ability to organize by either grouping into different clusters or classifications or perform smart search of the existing dataset in order to retrieve documents relevant to a given query and also extensions of that query using topic recognition, synonyms, and so on. The automatic ontology induction system 500 may also be configured to perform an idea similarity entopic search, across the entire intellectual property (IP) distributed ledger, to help inventors determine if their ideas have competition.

In some embodiments, a hybrid of approaches may be used by the automatic ontology induction system 500, that include pattern and rules based 501, and statistically based 502. The pattern and rules based 501 approach may use a list of highly precise rules that represent the different ways in which ontological information is represented in text. The advantage of using this approach is that it has very high levels of precision. The disadvantage is that it is not able to account for new classes, or even new representations of the ontology classes. The statistically based 502 is statistical and is probabilistic in nature, such as word vectors. The advantage of using this approach is that it can discover semantics relationships that are not explicitly mentioned in text. Therefore, it casts a wider net to find relevant pieces of information from the wealth of our data source. The disadvantage is that has lower accuracy that rule based approaches. The automatic ontology induction system 500 may use a hybrid of these approaches, by using rule-based along with statistical to get the advantages of both—higher accuracy for the modules, along with higher coverage for automatic induction of ontology. This approach requires developing rules, along with developing machine learning models, and then using a weighted probability distribution ranking-based approach to pick the right candidates. The system 100 also includes functionality that will upload a large number of patents, scripts, song, or ideas, enable users 101 to analyze existing libraries of patents, including lapsed patents, to identify areas where possible current or past infringement may occur. This may be accomplished by cross-referencing the patent libraries with data obtained from a variety of public databases, including and without limitation patent databases, business databases, product literature, technical papers, media announcements, and so forth.

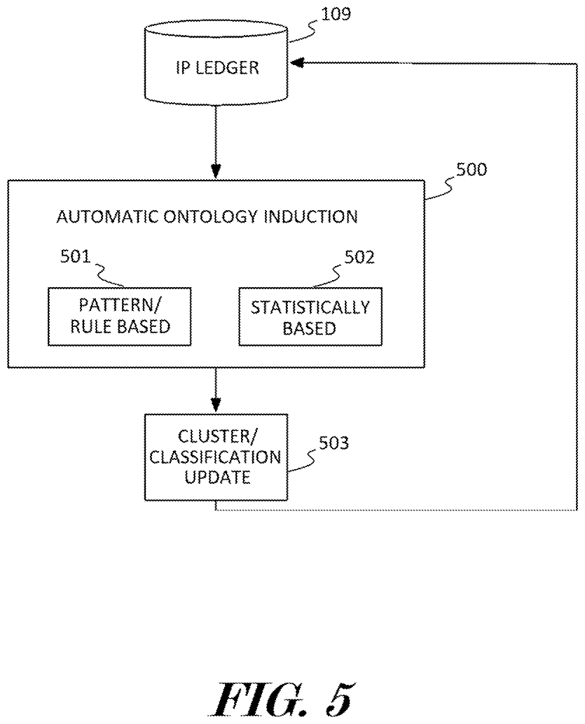

FIG. 5 is a block diagram showing an example of an automatic ontology induction system 500 according to one embodiment of the present invention and other components of the architecture and other participants in the system. Some specific functions provided by the automatic ontology induction system 500 may include: informing search for content or users 101 within an innovation eco-system; and facilitating intelligent, fine resolution entitlement capability to ensure that confidential information is not divulged inappropriately in an innovation platform. The automatic ontology induction system 500 combines and integrates these functions to enable a new kind of innovation framework to enable client devices 4400 configured as digital innovation hubs to transform current corporate innovation processes.

Modifications to the Blockchain “Mining” and “Proof of Work” System

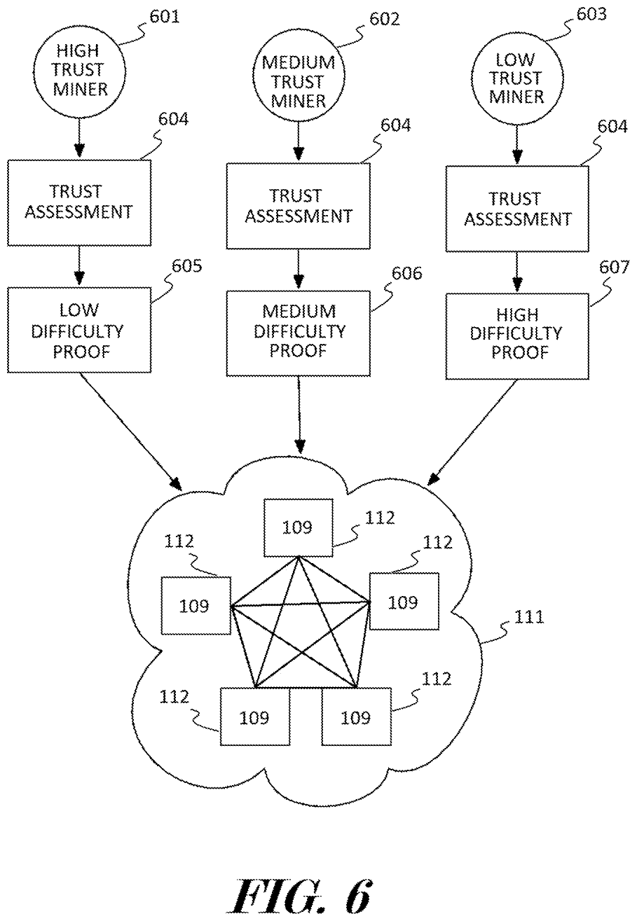

FIG. 6 is a block diagram showing how the modification to blockchain mining works according to an embodiment of the present invention and other components of the architecture and other participants in the system 100. In some embodiments, the system 100 may provide a modification to the Blockchain “Mining” And “Proof of Work” System, based on an adaptive approach to mining to assure an appropriate level of security while reducing the overall cost of operation. In preferred embodiments, the system 100 provides a novel optimization of the underlying blockchain architecture by using a process called trust enabled adaptive mining—an approach that assures an appropriate level of security while reducing the overall cost of the operation provided by miners to support a blockchain infrastructure. The system 100 may compute reputation values and assign penalty values periodically to miners with lower reputation score to perform a trust assessment 604. The trust enabled adaptive mining protocol may operate in three phases: setup, learning and operational phase. In the setup phase, the distributed computing system is initiated. In the learning phase, the local penalty values may be modified on the basis of the fraud detection techniques and external business reputation. In the operational phase, reputation values are used to re-compute costs based on variable proof of work requirements, for example low difficulty proof of work 605, medium difficulty proof of work 606, and high difficulty proof of work 607. The protocol is adaptive because the reputation values are modified periodically, according to the detected fraud and faults, including security breaches of the miner's infrastructure and publicly noted incidents of fraud and collusion. The system 100 may further include the use of a trustability index based on the trust objects, described later, to embedded into the IDs of the mining entities doing the encryption. The system 100 may use these trust object scores of miners 601, 602, 603, and participants to assess trustability of the IP Ledger blockchain database 109 so that the IP Ledger blockchain database 109 may be maintained via trust enabled adaptive mining. Anyone from a country to a company to an individual could host a blockchain server 3300, but a minimum trust score may be required, which may help to weed out potentially fraudulent servers in the federation pool.

Appstore for Related Applications

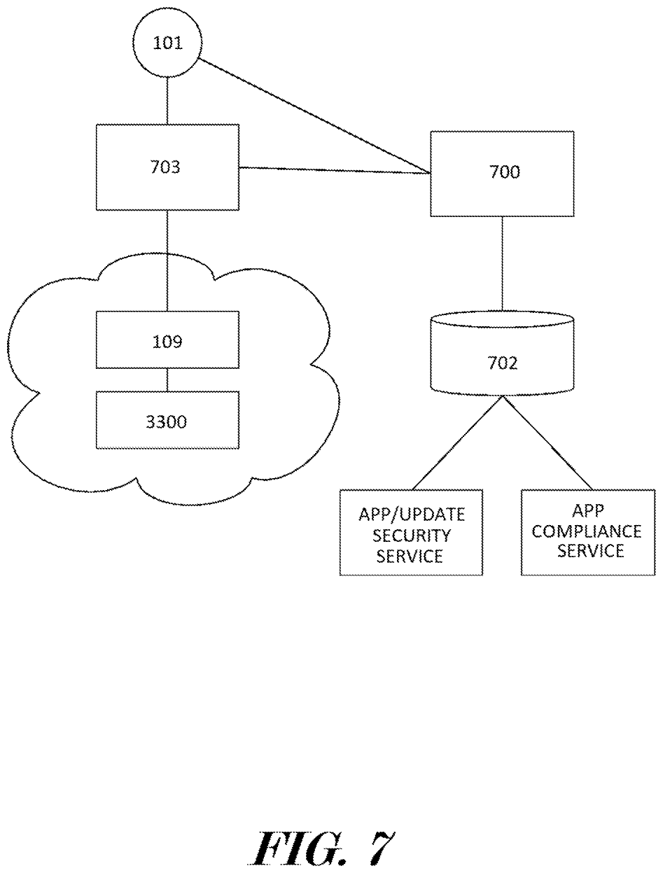

FIG. 7 is a block diagram showing an example of how the system 100 may provide an appstore 700 for applications that deal with intellectual property works according to an embodiment of the present invention and other components of the architecture and other participants in the system. In some embodiments, the system 100 may comprise or provide access to an appstore for applications that deal with intellectual property, using trusted extensions of functionality to the system 100 to provide one or more of the following advantages: a user 101 can easily navigate an application store 701 to identify and download applications from an app repository database 702 via a server 3300 dealing with intellectual property and innovation, to install into the system to enable additional functionality. These applications will include intellectual property “wallets” 703, intellectual property analysis, support for licensing or monetization, and so on. Users 101 may be notified of updates to previously downloaded applications without navigating to an update interface. Users 101 may be quickly provide feedback on applications including rating the intellectual property and innovation applications and reporting identified problems, or automatically rating them based on normal usage patterns. Additionally, users 101 may quickly and easily share information on particular applications of interest with other users 101.

Partial Transparency Transactionalized Search

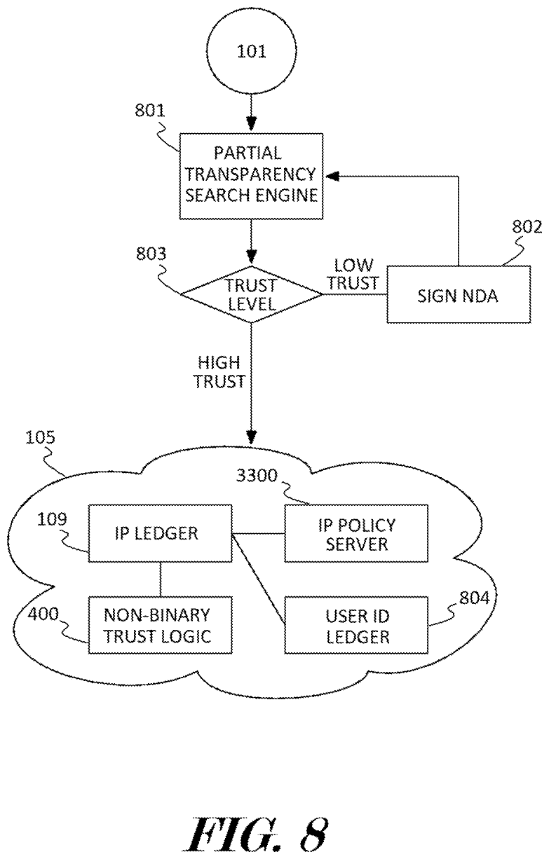

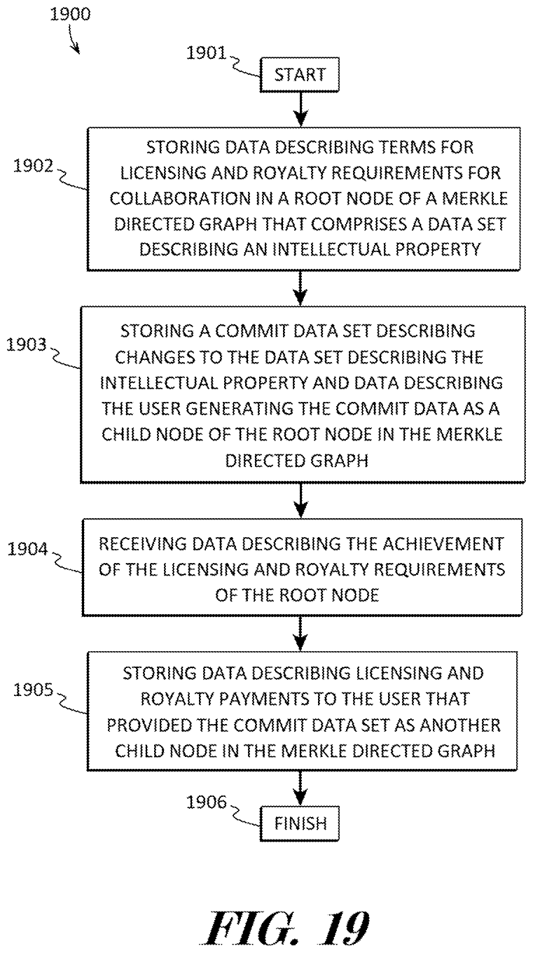

FIG. 8 is a block diagram showing an example of a partial transparency transactionalized search workflow according to an embodiment of the present invention and other components of the architecture and other participants in the system 100. In preferred embodiments, the system 100 may provide a method (FIG. 19) for performing partial transparency transactionalized searches via a partial transparency search engine 800, which may allow users 101 to more easily search for ideas, collaborations and potential project team participants while retaining the capability to release confidential information only under specific, assured circumstances. In other words, a search can become a transaction that can benefit companies that are seeking resources and ideas but for whom confidentiality is an absolute requirement. This functionality enables trusted development companies to query inventor offerings to locate promising ideas for license or purchase, and inventors to seek development and marketing entities based on computable trust and reputation.

In some embodiments, a user 101 may query the partial transparency search engine 800 via a client device 4400. The partial transparency search engine 800 may determine the trust level of the user 101 and may require the user to sign a non-disclosure agreement 802 depending on the determined trust level 803 of the user 101 after which, optionally stored in a user ID distributed ledger 804 or blockchain, the partial transparency search engine 800 may grant access to all or portions of the information of the system 100.

A partial transparency transactionalized search solves the problem of how to participate in a marketplace exchange without using a centralized intermediary or escrow. In some embodiments, a secure distributed IP Ledger blockchain database 109 may be used as an integration framework that supports search of and between parties, communications between parties, the transfer of funds from one party to another party, and the ability to for the provisioning or transfer of deliverables by a seller to a buyer or for the benefit of a buyer. An example of this search functionality is to consider film producers who wish to query screenplay databases, in order to locate promising but closely held properties to license or purchase, and in which owners of that intellectual properly can decide whether to release that information based on the desirability and trustability of the parties for the initiation of partnership. The search therefore unfolds via a trust establishing process, utilizing dynamic privacy level as a function of the position and trustability of searchers, which essentially transactionalizes the search process.

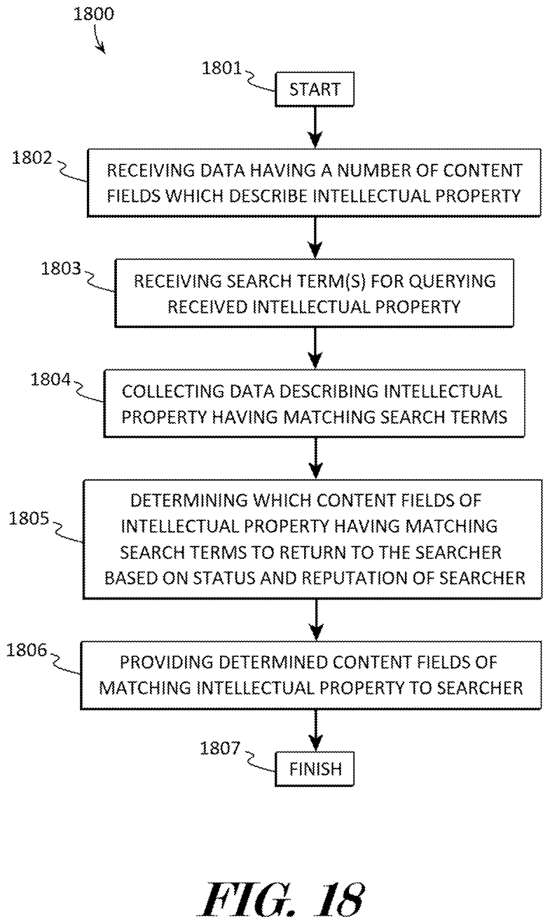

Referring also to FIG. 18 and in preferred embodiments, the system 100 may provide a method for performing a partial transparency transactionalized search of intellectual property (“the method 1800”). The method may start 1801 and data having a number of content fields which describe intellectual property may be received in step 1802 from a user 101 via their client device 4400. They may have content which may include Title, Author, Short abstract, Full content, Fee authorized and Access Policy.

In step 1803, one or more search terms for querying the intellectual property may be received from a searching user 101 via their client device 4400. For example, a searcher may enter search query term(s) into a form in the search field of a graphical user interface of their client device 4400.

In step 1804, the partial transparency search engine 801 may collect data describing intellectual property having matching search terms for the IP Ledger blockchain database 109 and/or from any other database of the system 100.

In step 1805, the partial transparency search engine 801 may determine which content fields of intellectual property having matching search terms to provide to the client device 4400 of the searching user 101 based on status and reputation of searching user 101.

In step 1806, the partial transparency search engine 801 may provide the determined content fields of matching intellectual property to searching user 101 and the method 1800 may finish 1807.

In further embodiments, the system 100 may provide a method for performing a partial transparency transactionalized search which may comprise: (a) search, by a client device 4400 of a second entity (user 101), for an idea declaration produced by a first entity in a database held by a third entity client device 4400 or number of client devices 4400; (b) generating, by the third entity client device 4400 or number of client devices 4400, the trust profile for the second entity required by the first entity; (c) transmitting, by the third entity client device 4400, to a second entity client device 4400, the transfer of the idea declarations and descriptions matching that trust level requirement, and suggested actions for increasing trust level for viewing more detailed descriptions of other idea declarations in the distributed ledger; (d) agreeing, by the second entity, to increase their trust level by digitally signing a confidentiality agreement to view more detailed descriptions; (e) transmitting, by the second entity client device 4400, to a third entity client device 4400 or number of client devices 4400, the digitally signed confidentiality agreement, (f) transmitting, by the third entity client device 4400 or number of client devices 4400, to a second entity client device 4400, the detailed descriptions of those other idea declarations in the distributed ledger; and (g) receiving, from the first second entity client device 4400, by the third entity client device 4400 an indication of the successful transfer of idea declaration and detailed descriptions, for notation into the distributed ledger.

Although certain aspects of the present invention are described herein within the exemplary context of the film production and screenwriting environment, it is to be appreciated that the invention is not so limited, and that aspects of the present invention are applicable in any type of intellectual property rights management environment.

The partial transparency transactionalized search functionality provided by the partial transparency search engine 800 enables the formation of open collaborative laboratories, where researchers outside of an organization could more easily collaborate with researchers inside an organization, where confidentiality and intellectual property constraints presently make it impossible to freely disclose internal discussions without significant managerial overhead. The system 100 may enable an automated entitlement capability to ensure that confidential information is not divulged to the wrong parties, and paired with partial transparency tranactionalized searches, the system 100 may allow for research teams to search for more promising participants and releasing confidential information only under explicit circumstances.

In the exemplary context, partial transparency transactionalized search is easy to develop for and deploy in this environment, because the framework contains resources for efficiently building applications that work within and between organizations, providing simplified access to profiles, content, and workflow/activity streams, with programmatically managed entitlement and permissioning.

In further embodiments, the system 100 supports performing such automatic searches at user defined intervals (such as every month), or at the occurrence of user-specified events, such as whenever the distributed ledger of intellectual property is updated. These embodiments allow the customer to define such automatic searches. In defining an automatic search, the customer specifies the target databases (what distributed ledgers to search), the target groups (which groups receive the identified documents), the search criteria, and the frequency or circumstances that the automatic searches take place.

Some specific functions provided by the partial transparency transactionalized search engine 801 may include: enabling trusted parties to query the dataset to locate promising ideas for license or purchase, and collaborators based on computable trust and reputation; facilitating partnering agreements between parties within an innovation eco-system; facilitating intelligent, fine resolution entitlement capability to ensure that confidential information is not divulged inappropriately in an innovation platform; managed IP portfolio visibility, real-time status reporting, and strategic IP analysis and optimization, extending not only to issued patents, but to invention disclosures and managed trade secrets as well; and intelligent and transactionalized data mining of IP portfolios and targeting of potential licensees. The partial transparency search engine 801 combines and integrates these functions to enable a kind of new innovation framework which enables client devices 4400 configured as digital innovation hubs that transform current corporate innovation processes.

In preferred embodiments, a partial transparency transactionalized search or transactionalized blind search enables the ability to query both publicly available documents, as well confidential ones with variable transparency based on reputation for selective disclosure. The content for blind search may be preformatted for selective disclosure and transactionalization by offering access policies based on reputation and other criteria. Non-formatted content may still be searched and integrated with the assumption that content is fully disclosed to all parties. The content may include Title, Author, Short abstract, Full content, Fee authorized and Access Policy. A searcher would enter a search query term into a form in the search system and submit it. The system 100 may review the searcher's status and reputation, and determine what information to return to the searcher, along with options for improving the status to increase the amount of information to be returned. The searcher may respond with the requested information to increase the amount of information to be returned. The system may then return the increased information per upgraded status.

In further embodiments, the system 100 may collect search terms as they are being typed and offer search suggestions based on incremental search queries and impact analysis for improving the searcher's status level. In further embodiments, the system 100 may charge a fee or token(s), to offer improved search results. This token(s) may be: payable to the owner of the information; may be “burned” and destroyed; and/or may be used as a donation to a charitable cause. A simple example of how works would be for Hollywood film producers looking for screenplays. In this case, screenplay writers don't want their ideas stolen by unscrupulous producers, and leading producers don't want others to know what they're interested in producing next. In order to locate promising but closely held properties to option, license or purchase, producers need to do it discreetly so they don't alert their competitors about their upcoming projects. On the flip side of the transaction, screenwriters will want to know something about the people interested in their work before allowing access—for example, is the producers someone with a reputation for stealing ideas.

In still further embodiments, the system may be configured to optimize the search process by enabling special trusted processes that optimize the search and metadata management process that can seek pareto efficient improvements and mitigate systemic risk. This enables the system to automatically generate keywords, generate emergent classifications to improve search, and help determine idea duplication via topical analysis. Special access rights may be granted to the system 100, in a trusted manner, to enable this optimization process, preferably with at least the abstract of the idea provided to the process, in a trustable manner, and returning the benefit of the results to the system 100 and earning tokens and incentives for doing so. This may be referred to as “optimization mining”.

In preferred embodiments, the system 100 may comprise a search engine that is cognizant of these requirements—deciding intelligently during the search whether to release information and to whom, what we call “blind search”. The search therefore unfolds via a reputation scan and trust establishing process, utilizing dynamic privacy level as a function of the position and trustability of searchers, which essentially transactionalizes the search process, unlocking content based on who the searcher is. This can be applied to many other areas of endeavor.

In some embodiments, the decision for how the access is managed by the system 100 may be performed according to the example of Table 1 in which Access Levels (Title, Author, Short abstract, Fee request, Content)=[TASFC] are limited by the reputation and status of the searching user. A decentralized identifier (DID) may comprise a globally unique identifier that does not require a centralized registration authority because it is registered with distributed ledger technology or other form of decentralized network. Verified claims may comprise cryptographic objects having a set of attributes that have been digitally signed by an issuer. The signature of the issuer serves as an attestation that the attributes in the claim are true. These are also referred to as Trust Objects 901.

TABLE 1
Access Level Defined by
Status and Reputation Matrix

| | Reputation | | |
|---|---|---|---|
| Status | Poor | Medium | Good |
| No DID | [ ] | [TF] | [TF] |
| DID known, Sector | [T] | [TF] | [TAF] |
| undisclosed | | | |
| DID, Sector & | [TF] | [TF] | [TAF] |
| Competitive | | | |
| DID, Sector & Not | [TAF] | [TAF] | [TASF] |
| Competitive | | | |
| Blanket NDA signed | [TAF] | [TASF] | [TASF] |
| with real ID | | | |
| Specific NDA signed | [TASFC] | [TASFC] | [TASFC] |
| Access Fee Paid | [TASFC] | [TASFC] | [TASFC] |

Using the aforementioned example, the searcher is using an authenticated ID, has disclosed they are a producer and looking for screenplays, and have signed a blanket NDA provided by the system 100. They enter the term “Greek historical figures” and the system 100 will return a result that states: [324 open results, 129 blind results, 22 requiring NDA, 19 requiring fee]. The user can then sign the specific NDA or pay a fee, to access additional results. In any case, the system 100 may offer a “contact inventor” option, which would send a message to the inventor, along with the status of the searcher. That status could allow the inventor's messaging system sort or filter results based on having signed a specific NDA or paid a fee.

In preferred embodiments, the reputation system utilizes both transactional and non-transactional data. Transactional data includes a record of search attempts and reviews by inventors. Non-transactional data includes trust primitives such as verified claims or trust objects, such as a verified listing in IMDB that asserts the successful production of a number of theatrically released films. This reputation system would be continuously updated and refined. In further embodiments, the system 100 may also provide user interface client devices 4400 to simplify the access control logic, so a simple dial can turn up or down the difficulty of access for all status and reputation levels easily. The system 100 allows the intellectual property creator (screenwriter in this example) to defend their ideas from competitors, but at the same time, enable trusted intellectual property buyers (film producers in this example) with positive reputation to consider their work for purchase. In this manner, the system is able to enable blind searches, so trusted film producers could query screenplay databases, in order to locate promising properties to license or purchase, but untrusted ones would be unable to obtain such information, unless additional processes were undertaken to establish greater trust. Thus, content creators could set the privacy level as a function of the position and trustability of searchers and also turn each search into a transaction.

Persistent and Encapsulated Software Trust Objects

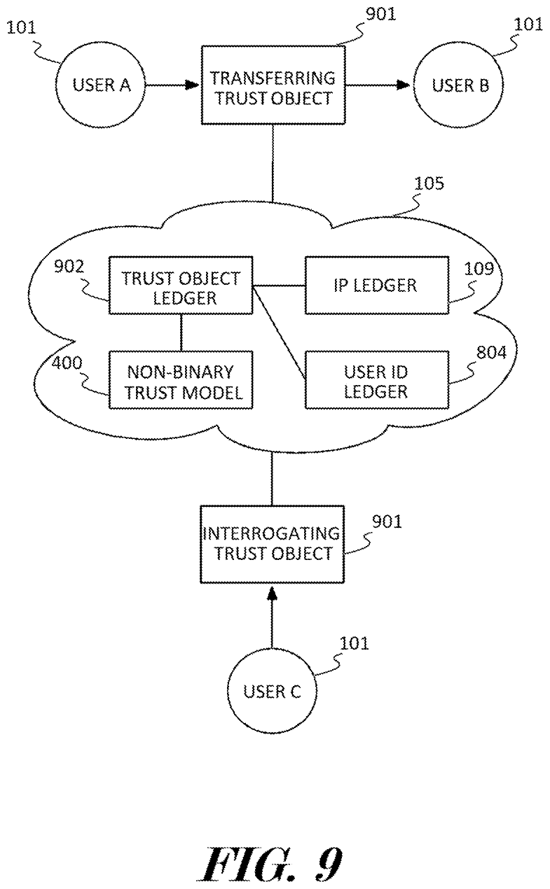

FIG. 9 is a block diagram showing an example of the use of trust objects by a non-binary trust model 900 of the system 100 according to an embodiment of the present invention and other components of the architecture and other participants in the system which may provide authentication of communication between entities. For example, the communication may be electronic communication is the form of electronic messages such as emails, files or news articles that may be shared among the entities. In some embodiments, the system 100 may comprise a non-binary trust model 900 may be implemented as a cloud of servers 3300. Further, non-binary trust model 900 may encrypt and/or verify the communication along with the timestamp, source identity and trust level. In some embodiments, the non-binary trust model 900 may verify the authentication of communication by checking various checksums or hashes for archived files. In further embodiments, the non-binary trust model 900 may provide trust object and markers that authenticate multiple relationship factors related to the entities and/or between the entities. Further, the non-binary trust model 900 may require an explicit approval from an entity before releasing any personal information. In still further embodiments, if an entity has several trust markers associated with the identity information, then identity subsystem may provide a first pass trust information to authenticated communication by informing about the number and quality of the trust markers.

In some embodiments, the system 100 includes persistent and encapsulated software trust objects 901 which assess business and social reputation; track levels of trust and enable trading trust objects and markers, and the non-binary trust model 900 may use this as a basis for recording trust level on a trust object distributed ledger 902 or blockchain and in the operation of fine-grain access models to confidential information. In emerging Internet parlance, trust objects 901 may be referred as “verifiable credentials” and “verifiable claims” and fine-grain access models as “selective disclosure”. In preferred embodiments, authentication is the baseline, and access depends on the level of trust between the parties 101 (in this example, user A, user B, and user C). Like a credit card transaction, the system 100 includes active and adaptive fraud detection and trust scoring to allow or deny access to confidential information. The non-binary trust model 900 may collect trust objects 901 and may mathematically convolve all assigned objects and markers to produce a multi-dimensional assessment of business risk, with dimensions include, without limitation, size of transaction, domain of trustability, and so forth.

Examples of trust object 901 and markers may include, but are not limited to, digitally signed validations of working relationships, credit history, account balance estimates, college transcripts or graduation verifications, employment verifications, personal recommendations, and so forth. The requirement of authentication and trust may be explained with an exemplary scenario of a landlord and a prospective tenant. The landlord may perform a check on the prospective tenant for a residential apartment tenancy application by calling the bank holding the accounts of the prospective tenant and requesting information on which to build trust for the tenant. However, the caller may not be authenticated over the phone, the bank may not provide an exact account balance, but may provide less detailed information such as “this person has a four-figure balance and has never bounced a check”. Therefore, even providing less detailed and occluded information may allow the prospective landlord to increase trust in the tenant, which however is a normal service of personal banking. In some embodiments of the system 100, both the query and the response may be authenticated to increase security. Also, the weight and quality of the trust markers such as financial and security clearance information, as well as college and high school diplomas and honors, may be higher than the quality of trust markers such as personal references from social network friends.

Thus, non-binary trust model 900 may include the use of one or more trust objects 901, which can help members of the eco-system to find better matches of people and ideas for collaborations, leverage reputation and use a “non-binary” trust models. Essentially, a trust object 901 atomizes the essence of trust, so it can be shared more reliably over business and social networks. In the exemplary context, the system 100 may require the establishment of certain underlying services to enable rich and robust collaboration between businesses, such as business identity servers, metrics of trust, time, location. Thus, the system 100 may also establish a distributed methodology for describing and authenticating users 101 such as people, consumers, businesses, markets, and their agents. The system 100 preferably weights reviews that impact trust, based on the computed weight of trust of the reviewer. Computational trust may be assessed with a variety of techniques, including Bayesian probability estimation, discrete probability distributions, rules based logic, heuristics, and machine learning.

Some specific functions provided a system 100 configured as a non-binary trust system may include: enabling trusted parties to query the dataset to locate content or users based on computable trust and reputation; facilitating partnering agreements between parties within an innovation eco-system based on trust levels; and facilitating intelligent, fine resolution entitlement capability based on trust levels. The system 100 may combines and integrates these functions to enable a novel kind of innovation framework that ay enables client devices 4400 configured as digital innovation hubs to transform current corporate innovation processes.

Licensing Royalty Smart Contract with Auditable Payment Tracking

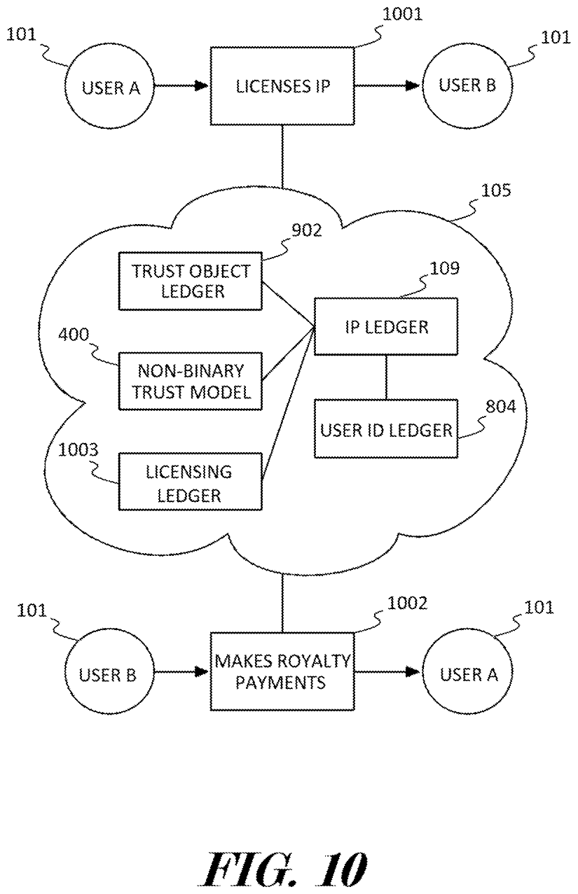

FIG. 10 is a block diagram showing an example workflow which may be performed by the appstore for applications that deal with intellectual property according an embodiment of the present invention and other components of the architecture and other participants in the system 100. In some embodiments, the system 100 provides the ability to generate and automatically track licensing royalty contracts to enable self-auditing licensing payment execution and auditing 1001. In preferred embodiments, the system 100 may be configured to store data in a licensing distributed ledger 1003 which may: enable a user to easily add the functionality of a “smart contract” to enable automated payment terms for licensing of intellectual property, with the terms of a contract being both machine and human readable; provide an exchange for forming contracts between a plurality of users, in which a number of contingent legally binding contracts must be completed to enable the smart contract to be activated; contract tracking and monitoring contract performance, of deliverables, acceptances and payments of licensees; perform or make royalty payments 1002; calculate risk and trustability users of licensees based on the data generated monitoring contract performance; and auditing contract performance, of both deliverables, acceptances and payments of licensees, which is also called “triple entry accounting”.

Referring also to FIG. 19 and in preferred embodiments, the system 100 may provide a method for creating a licensing royalty smart contract with auditable automated payment tracking (“the method 1900”). The method 1900 may start 1901 and data describing terms for licensing and royalty requirements for collaboration may be stored in a root node of a Merkle directed graph 120 that comprises a data set describing an intellectual property in step 1902 from a user 101 via their client device 4400. In further embodiments, the system 100 may note in the information about a root idea node, the terms for licensing and royalty requirements for collaboration. The system 100 may divide a reward by the number of notable contributors to the refinement and improvement of an idea, as determined by the inventor or a governance body or algorithm. An example, without limitation, is that the inventor of an intellectual property could state that 3% of the total royalty or token budget will be shared by the 7 most valuable contributors, with 25% of that going to the two top contributors and the balance going 1% each to the next five. A variation of this could be that an algorithm assigns royalty points or tokens based on contributions that earn a certain number of votes by the contributor community.

In step 1903, the system 100 may store a commit data set 123 describing changes to the data set describing the intellectual property and data describing the user 101 generating the commit data as a child node of the root node in the Merkle directed graph 120. Preferably, the system 100 may track contributions of idea refinement or improvement, noting the contributor, votes, and pointers to the text, image and video files that provide evidence of collaboration and store as one or more further child nodes in the Merkle directed graph 120. Optionally, when an idea is deemed to be complete, and potentially a patent is filed to support it, the inventor or governance committee can declare that incentives will be allocated, and optionally declare that a reserve has been established to reward ongoing refinement which may also be stored as one or more further child nodes in the Merkle directed graph 120.

In step 1904, the system 100 may receive data describing the achievement of the licensing and royalty requirements of the root node. For example, when an idea (described by data in the root node) is licensed, monetized, reduced to practice or used to execute a contract that generates revenues, the system 100 may record that this has occurred and automatically inform all parties, as specified in the terms of the root idea node instantiation or creation.

In step 1905, the system 100 may data describing licensing and royalty payments to the user 101 that provided the commit data set 123 as another child node in the Merkle directed graph 120. Preferably, as payments are made to the users set forth in the licensing and royalty requirements for collaboration, information about the payment stream can be reported and storied to the Merkle directed graph 120, which will create an immutable record of payments collected, and the system 100 may manage the automated disbursement of revenues and royalties to the collaborators. Alternatively, the inventor can pay collaborators directly, providing proof of payment to the system 100 to be recorded to the Merkle directed graph 120. After step 1905, the method 1900 may finish 1906.

In further embodiments of the method 1900, the system 100 may then use this information about reduction to practice and payment streams, to generate reputation histories for all parties in the collaboration, including the inventor, the individual collaborators, and the licensee or idea implementors. These reputation histories can be used to help participants decide which ideas to support in the future. In still further embodiments, the system 100 may perform a Merkle proof that validates branches of the tree incrementally, to validate the idea and payment stream, or some component of it, is a valid branch of the tree and has not been modified. In alternative embodiments of the method 1900, the method 1900 may cover forking or merging idea graphs, having “optimization process” run over the system to detect fraudulent activity, reduce systemic risks or otherwise optimize systems, provide a fraction of the royalty stream or incentive token pool to underwrite the cost of an adaptive patent pool to protect entire idea trees.

Micro-Equity Incentives and Tokens

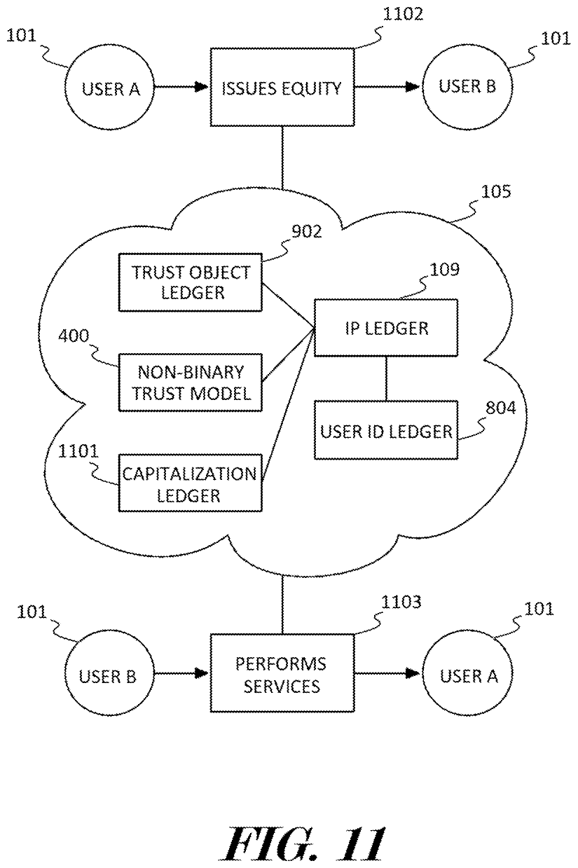

FIG. 11 is a block diagram showing an example workflow of how the system 100 may automatically track equity incentive contracts according to an embodiment of the present invention and other components of the architecture and other participants in the system 100. In some embodiments, the system 100 may be configured to store data in a capitalization distributed ledger 1101 which may provide the ability to easily generate and automatically track equity incentive contracts, which are also referred to as “tokens”, to provide self-auditing capitalization tables, more secure equity arrangements, and exit/monetization tracking. In preferred embodiments, the system 100 may be configured to store data in a capitalization distributed ledger 1101 which may enable a user 101 to easily add the functionality of equity incentives 1102 to recruit mentors, advisers, referral partners, service providers and supporters, with simplified terms for equity compensation for proposed efforts, with the terms of a contract being both machine and human readable. In further embodiments, the system 100 may form and manage equity incentive contracts between a plurality of users 101, with the ability for the user 101 to quickly provide feedback and ratings on mentors, advisers, referral partners, service providers and supporters in the form of trust objects. In still further embodiments, the system 100 may be configured to provide services 1103 which may include real-time monitoring, can report to participating mentors, advisers, referral partners, service providers and supporters information regarding equity investment, capitalization tables, and exits, as well as payments to intellectual property licensors. In still further embodiments, the system 100 may be configured to provide services 1103 which may include calculating risk and trustability assessments of equity offers, intellectual property licensors and licensees, past performance of startup mentors, advisers, referral partners, service providers and supporters, all based on the data generated monitoring performance. In still further embodiments, the system 100 may be configured to provide services 1103 which may include automatically auditing and reporting on capitalization tables, using what is called “triple entry accounting”.

Automated Fraud Detection

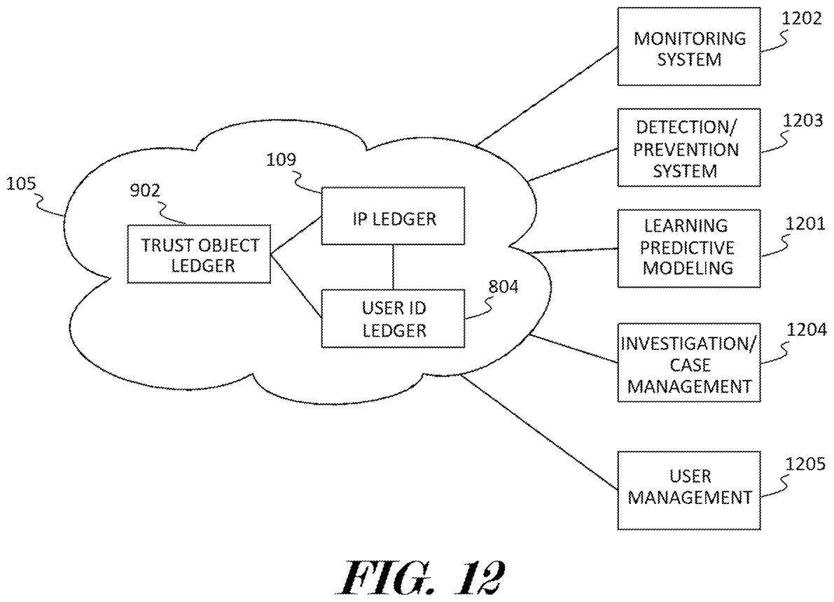

FIG. 12 is a block diagram which illustrates how the system 100 protects against fraud and malware according to an embodiment of the present invention and other components of the architecture. In some embodiments, automated fraud detection methods may be based on neural networks and machine learning and predictive modeling 1201 and may include methods for scanning the intellectual property distributed ledger 109 and trust objects 901 to detect patterns that can indicate fraudulent behavior, malware and a traffic patterns. The system may further protect against fraud and malware by providing a monitoring system 1202, detection/prevention system 1203, investigation/case management 1204, and/or user management 1205 functions.

Intellectual Property Management Dashboards

In some embodiments, the system 100 may provide dashboards and graphical user interfaces via client devices 4400 that provide visualization and analysis of, without limitation, innovation, intellectual property and trust metrics that are tracked by the overall system 100. In further embodiments, a computer graphical user interface may provide access to information stored on a computer-readable medium that pertains to a selected idea, innovation or patent application is described contained in an IP ledger 109 or other distributed database 1101, 1003, 902, 804. In further embodiments, a computer graphical user interface may provide access to information stored on a computer-readable medium that pertains to a plurality or portfolio of ideas, innovations or patent applications is disclosed. In further embodiments, a computer graphical user interface provides access to information stored on a computer-readable medium that pertains to innovation, collaboration, utility and risk metrics that are tracked and displayed in a system of graphic dashboards and through a workflow tracking system.

The primary goals for the dashboard may include, without limitation: (i) to give the user a quick sense of what's going on; (ii) to analyze the pipeline of innovations and to locate and address parts of the collaboration pipeline that are not being effective or require attention; and (iii) to make decisions about which ideas to develop or innovations to fund or tasks to perform. The dashboards include, without limitation, a collaboration pipeline dashboard, a collaborative decision-making dashboard, a pivot analysis dashboard, a collaboration impact analysis dashboard, a social metrics dashboard, and a social workflow dashboard. As an example, we can consider the collaborative decision-making dashboard, in which the interface is based on an interactive weighted decision matrix, where a user or group of users can individually or collectively adjust the weights of factors and multiply them against polling results, to create a “utility function” that represents the needs of the collective. The key is that the weights have to add to 100%, so if the user increases the weight or value of one factor, the other factors need to be reduced proportionately to add up to unity. An exemplary embodiment of this may be fully interactive with immediate feedback, so when the user increases a specific weight, the other weights are proportionally reduced, so it always adds to 100%. At the same time, the scores for each of the items or options are updated in real-time, so the user is able to perform a what-if analysis. Using this utility function, the system can list various items or options by utility or value, and when you click on that graphical element representing that option or item, additional information is displayed for that item or option. The analysis can then be broadened to multi-user usage, by allowing a multiplicity of users to see and interact with other's utility function settings in real-time to better understand their partner's decision process. The system 100 can identify outliers and prompt discussion to normalize divergent assumptions. Additionally, once a number of decision makers have completed their analysis to select the options or items they wish to move forward with or eliminate, they can meet in a virtual space to compare their choices or use multi-voting techniques to narrow the field of preferences. Multi-voting means that one or more users give multiple votes to various ideas or proposals, and the tally may provide an ordered list by global utility. The distribution of multi-votes can be varied, and the input of various users can also be weighted dynamically. An exemplary embodiment of this may fully interactive with immediate feedback, so when one user sets a weight or changes a multi-vote proposal, the other weights and voting components are proportionally reduced, so it always adds to 100%, and it updates all users immediately. For the collaboration impact analysis dashboard, the interface allows users to view a variety of chart types that display the impact of various items or options, against their costs, time to development or implement, strategic alignment with other goals, and so forth.

Although certain aspects of the present invention are described herein within the exemplary context of the collaborative decision-making dashboard, it is to be appreciated that the invention is not so limited, and that aspects of the present invention are applicable many other visualizations in the dashboard environment.

Innovation Workflow Broker

In some embodiments, the system 100 may be configured to enable managing innovation workflow which drives progress and process of collaborations and innovation work. The workflow process is the process of routing tasks and documents to predetermined users, notifying the appropriate users of required tasks, periodically reminding users of task completion deadlines, and tracking time periods associated with both tasks and the time between tasks, all according to a user-defined workflow process design. Workflow examples include the routing of invention disclosures to a working practitioner for drafting patent applications, circulation of draft patent applications to inventors and managers for review and comment, circulation of Patent Office forms to inventors and managers for signature, notification of practitioners of the receipt of Patent Office actions and papers, and routing of documents to service providers (e.g., informal drawings to a draftsperson for creation of formal drawings) as needed. In general, workflow is limited to within an enterprise, and this embodiment of the present invention allows for workflow to operate securely across enterprise boundaries and within an eco-system, while maintaining the confidentiality of any documents or intellectual property. This is implemented by the creation of an intermediary network and workspace, where collaboration is performed with trusted partners of the entities or across multiple organizations. Finally, by understanding the nature and structure of ideation and innovation design process, the workflow broker can be organized to optimize collaboration. Applications that are trusted may be allowed to execute in the intermediary network.

Innovation Optimization Tools

In some embodiments, the system 100 may include optimization tools which allow innovation managers to visualize, optimize and risk reduce innovation efforts under their management. The underlying system gathers metrics about the flow of ideation and collaboration and applies tools that can lead to optimizations to improve the quality of ideation and speed of collaboration within and between groups or enterprises.

In further embodiments, the system 100 may include an idea similarity analysis engine that detects similar ideas using deep learning and uses a network of trusted “AI trainers”, who are compensated by the system in exchange for teaching the system how to differentiate between ideas. This will aid in preventing the “re-invention of the wheel” at organizations with poor corporate memory and will promote more positive and effective collaborations.

In further embodiments, the system 100 may utilize adaptive boosting to more rapidly determine reputation for better voting, rating, and ranking, which enables the system to assist users to more effectively locate team members, investors, investors and resources. Adaptive boosting is a machine learning meta-algorithm that can be used in conjunction with many other types of learning algorithms to improve their performance.

In further embodiments, the system 100 may provide the ability to optimize eco-systems to remove inefficiencies, such as, without limitation, over- and under-investment in certain sectors of a portfolio, under performance in terms of collaborative efficiency, and inappropriate skills matching for collaborations. The system 100 may also include the ability to leverage disruption maps, to map against predictions of emerging technologies and market opportunities to improve reaction times for addressing emerging opportunity spaces.

Disruption Mapping

In some embodiments, the system 100 may include emerging disruption visualization tools which allow innovation managers to visualize future scenarios by tracking, visualizing and managing emerging threats and opportunity spaces, to optimize and risk reduce innovation efforts under their management. The underlying system collects data from both intra- and extra-enterprise systems about emerging technology trends and applies tools that can lead to optimizations to refine the innovation strategies of individual inventors, enterprises, consortiums and national innovation ministries.

Specialized Ideation Capture Devices

In some embodiments, the system 100 may comprise one or more client devices 4400 which may be configured as specialized ideation capture devices. For example, without limitation, in the use of inventor journals, the system 100 may include the use a plethora of different types of client devices 4400 including: (i) digital pens and tablets, (ii) audio and video recordings by the inventor, (iii) recorded and annotated calls with co-inventors, (iv) digital whiteboard group brainstorming application, to immediately record and timestamp incremental invention data directly to the immutable IP Ledger blockchain databases 109, thereby strengthening the assertion of time and nexus for data to support an invention or intellectual property. This may increase the trust score in the underlying non-binary trust system. The system 100 may monitor many factors about the context of the data capture, including who is in a workgroup, what is the stage of the ideation work, the absence or inclusion of certain key words or phrases in the content developed, the overall velocity of collaboration as evidenced in the growth of the underlying idea graph, and other factors. Using this, the system 100 can highlight data and content that is more valuable in defending the intellectual property provenance.

In preferred embodiments, the system 100 is configured to enable users 101 to facilitate the preparation, securing and management of intellectual property rights documents and data, using one or more distributed ledgers 109, 804, 902, 1003, 1101, and related applications. A distributed ledger for intellectual property 109, using blockchain technology, allows the creation of a publicly or privately verifiable and unalterable record of intellectual property declarations, recordings, filings, prosecution, licensing transactions and payments, tracking and reputation management. In further embodiments, the system 100 may be configured to provide a method to enable users 101 to facilitate the preparation, securing and management of intellectual property rights documents and data comprising: (a) creation, by a client device 4400 of a first entity, an idea declaration in multiple formats for varying degrees of trust by a second entity or number of entities; (b) generating, by the first entity client device 4400, data required to secure the declaration into the distributed ledger; (c) transmitting, by the first entity client device 4400, to a third entity client device 4400 or number of client devices 4400, the transfer of the idea declaration and descriptions and the data required for securing the declaration into the distributed ledger; and (d) receiving, by the first client device 4400, from the third entity client device 4400 an indication of the successful transfer of idea declaration and descriptions.

In preferred embodiments, the system 100 may include one or more elements which forms a comprehensive foundation for an eco-system for innovation and intellectual property management. The elements may include: an intellectual property distributed ledger 109, an intellectual property digital policy server 3300, non-binary trust models 400, automatic ontology induction 500, modifications to the blockchain “mining” and “proof of work” system, appstore for related applications 700, partial transparency transactionalized search engine 801, persistent and encapsulated software trust objects 901, licensing royalty smart contract with auditable payment tracking 1001, micro-equity incentives 1102, automated fraud detection 1201, 1202, 1203, 1204, 1205, intellectual property management dashboards, innovation workflow broker, innovation optimization tools, disruption mapping, and intelligent just-in-time learning.

The system 100 combines and integrates these functions to enable personal, intra-enterprise, inter-enterprise and extra-enterprise recordation, collaboration, searchability and its benefits, licensing and tracking of information regarding intellectual property over a networked distributed computing system.

In further embodiments, the system 100 may be configured to provide one or more functions which may include: online creation of invention disclosures, witnessing, archiving and secure sharing of invention disclosures between technology developers and patent counsel; automated conversion of invention disclosures into patent applications and automated electronic filing of such applications with patent offices; facilitating the electronic filing and prosecution of patent applications in patent and offices worldwide, allowing all correspondence to and from patent offices to be paperless and with automated assurances of delivery and timely response; automated docketing by participating patent offices in a standardized database accessible to all authorized participants, electronic notification of due dates and electronic payment of annuity fees; semi-automated docketing by third party agents to service non-participating patent offices; non-binary trust models and persistent and encapsulated software trust objects that enable more accurate trust estimations and automated functionality based on trust estimations; automatic ontology induction allowing the system to automatically organize the data by grouping into different clusters or classifications to perform more effective search of the dataset; modifications to the blockchain “mining” system based on trust enabled adaptive mining to reduce the overall cost of operation; an appstore for applications that deal with intellectual property; partial transparency transactionalized search which may enable trusted parties to query the dataset to locate promising ideas for license or purchase, and collaborators based on computable trust and reputation; licensing royalty smart contract with auditable payment tracking to enable self-auditing licensing payment execution and tracking, aka “triple entry accounting”; micro-equity incentives with enables equity compensation to be managed in a way that motivates, optimizes and streamlines the collaboration process; automated fraud detection to protect intellectual property transactions from fraud and malware; intellectual property management dashboards to enable the visualization of innovation processes; innovation workflow broker which drives progress and process of collaborations and innovation work; innovation process optimization tools that provide visibility into intellectual property portfolios, real-time status reporting, and strategic IP analysis and optimization; disruption mapping which enable managers to better track, visualize and manage emerging threats and opportunity spaces; specialized ideation capture devices enables the system to record the process of invention to strengthen the provenance of ideation for intellectual property assertions; intelligent and transactionalized data mining of IP portfolios and targeting of potential licensees; online receipt and examination of patent applications and issuance of office actions by patent offices worldwide; coordinating, tracking and providing payment options for all financial aspects of the patent process including patent office fees, practitioner fees and service provider fees; coordinating, tracking and providing payment options for all financial aspects of the patent licensing process, including royalties, sales volume and other data; coordinating, managing and authenticating trust and reputation data for all of the above.

The system 100 combines and integrates these functions to enable personal, intra-enterprise, inter-enterprise and extra-enterprise recordation, collaboration, searchability and its benefits, licensing and tracking of information regarding intellectual property over a networked distributed computing system. These and other embodiments of the system 100, as well as its advantages and features, are described in more detail in conjunction with the text below and attached figures.

Connections of Main Elements and Sub-Elements of Invention

The two main elements, the intellectual property distributed ledger 109 and the intellectual property digital policy server 3300, and the many sub-elements are connected and interoperate in several ways. In general, the connections may occur in four types of element collections, around core functionality, trust, ledger, and user interface. The intellectual property distributed ledger 109 and the intellectual property digital policy server 3300 and the automatic ontology induction sub-element 500 inter-operate, requiring common application and data storage systems, and the appstore 700 for related applications extends functionality in a simplified way. The non-binary trust model sub-element 900 and the persistent and encapsulated software trust objects sub-element 900 work together, and in concert with the main elements, requiring their own application and data storage systems. The licensing royalty smart contract with auditable payment tracking 1001, micro-equity incentives 1102, and automated fraud detection sub-elements all work in a related manner, and in concert with the main elements, preferably requiring their own application and data storage systems. The intellectual property management dashboards, innovation workflow broker, innovation optimization tools, disruption mapping, and specialized ideation capture devices, all work in concert with the main elements, preferably requiring their own application and data storage systems. The main elements and sub-elements are in this way interconnected.

### DESCRIPTION OF VARIATIONS AND ALTERNATIVE EMBODIMENTS

Other embodiments can help to illustrate other capabilities of the present invention. The following are variations of the functionality of the invention. Accordingly, the alternative embodiments set forth below is not intended to limit the scope of the present invention in any way. One of ordinary skill in the art may recognize that other variations, modifications, and alternatives are possible.

For example, using the functionality of the present invention, an alternative embodiment of the invention may be in the arena of technology transfer at a University, by enabling a novel approach to licensing, by leveraging non-binary trust models, transactionalized idea search, intellectual property policy servers, persistent object models for idea metadata, and self-optimizing, cross-industry innovation team formation between university research personal and private ventures, and finally, which may provide for automated tracking of performance and ROI. The workflow broker may enable automated tracking of university research projects. The IP policy server may facilitate intelligent, fine resolution entitlement capability to ensure that confidential information is not divulged inappropriately. The distribution ledger for intellectual property 109 may track IP ownership of incremental discoveries, with automated agreements for licensing and partnership arrangements for ancillary and related inventions. Trust objects 901 and markers may enable reputation-based search to find contributions that are not openly advertised, but offered with partial transparency, essentially turning the blockchain into a digital IP marketplace. By becoming a “trust object authority”, the university may be able to grant graduates with digital verification of degrees awards. With the use of IP blockchain “triple entry accounting” the licensing process may integrate self-auditing of payments. The system 100 may allow the tech transfer office to gather and analyze more meaningful metrics for innovation and licensing at the university, or a consortium of universities.

An example of an alternative embodiment of the present invention may include the use of a blockchain of discovery that supports collaboration in life science research, or more specifically, vaccine research, that may provide a disruptive innovation in the coordination of academic and commercial research in treating and preventing global epidemics. This may enable a new kind of real-time coordination research using the blockchain and associated technologies, which may allow scientists to rapidly document and accelerate breakthroughs in a way that may provide confidentiality of the breakthrough via the transactionalization of the search process, and at the same time compensate all parties more equitably, enabling meta-coordination and optimization of global research efforts. The system 100 may include a blockchain to track ownership of incremental discovery, with automated agreements for licensing and partnership arrangements for ancillary and related inventions; the Intellectual Policy Server and Royalty Payment Accounting Blockchain to optimize the licensing of resulting intellectual property, with integrated self-auditing of payments; and use TrustObjects to create opaque reputation and enable “blind search” to find contributions that are not openly advertised, but offered with partial transparency indications of interest.

Another example of an alternative embodiment of the present invention may comprise a blockchain to record intellectual property ownership at an electronics consortium, which may enable automatic auditing of licensing fee and royalty payments and manage automated collaborative design and development. This could be thought of as “open source but with an embedded revenue model” and could decrease the cost of design across the lifecycle, to increase profitability for the design process. The embodiment may comprise the blockchain to track ownership intellectual property ownership for contributed code that has offers flexible variable licensing terms depending on the licensor and use of the system; blockchain accounting to optimize the IP licensing business for the eco-system, with integrated self-auditing; and Trust Objects to manage reputation and validate “units in production” rankings that inform royalty payment models, and enable transactionalized search to find code contributions that are not openly advertised, but offered with partial transparency.

Yet another example of an alternative embodiment of the present invention may comprise a blockchain to manage venture incubator communities, simplify the incubation process, enable reputation management to identify better mentors, provide a distributed ledger to track equity incentives for mentors, encourage more active participation. The embodiment may comprise methods utilizing the blockchain to increase visibility of the process of mentoring, better organize investor knowledge and communications, and assist in the process of capture and promotion of incubator best practices.

These aforementioned alternative embodiments provide a novel kind of real-time coordination research using the blockchain and associated technologies, which allows innovators and researchers to rapidly document and accelerate breakthroughs in a way that may provide confidentiality of the breakthrough via the transactionalization of the search process, and at the same time compensate all parties more equitably, enabling meta-coordination and optimization of global research efforts. The embodiment may comprise the blockchain to track ownership of incremental discovery, with automated agreements for licensing and partnership arrangements for ancillary and related inventions; the Intellectual Policy Server and Royalty Payment Accounting Blockchain to optimize the licensing of resulting intellectual property, with integrated self-auditing of payments; and use TrustObjects to create opaque reputation and enable “blind search” to find contributions that are not openly advertised, but offered with partial transparency indications of interest.

In a further embodiment of the present invention, the system may provide visualizing, managing and optimizing innovation within an entire country, rather than for a particular industry eco-system such as a consortium or incubator community. The system 100 includes the ability to visualize an eco-system's or nation's innovation portfolio to analyze both ideation and execution of innovation programs. It provides access to data within the development pipeline, tools that assess the robustness of the work in progress, and that correlate current projects with anticipated future scenario mapping. The present invention may include disruption mapping to generate continuous scenario mapping functionality.

In further embodiments, the system 100 may be configured to facilitate communication between users 101 in different countries via a “global innovation smart grid” that enables powerful new business models and functionality to emerge, that enables the formation of vibrant innovation partnerships between academia, government and industry, and that dramatically increases global innovation capacity and competitiveness.

An alternative embodiment of the present invention may comprise an open collaborative laboratory, where researchers outside of an organization may more easily collaborate with researchers inside an organization, where confidentiality and intellectual property constraints—which often make it impossible to freely disclose internal discussions without significant managerial overhead—are automated. The system 100 may enable an automated entitlement capability to ensure that confidential information is not divulged, and paired with partial transparency transactionalized searches, the system 100 may allow research teams to search for likely participants, releasing confidential information only under explicit circumstances. In effect, the system 100 enables each search to become a transaction.

An example of this alternative embodiment may include the formation of a public/private partnership to manage open licensing of IP from a multiplicity of universities and research institutes to biotech and pharma companies. The system 100 may create a blockchain of discovery that supports collaboration and may provide a disruptive innovation in the coordination of academic and commercial research in treating and preventing global epidemics. This allows scientists and pharmaceutical companies to more easily share information, and more rapidly document and accelerate breakthroughs in vaccine development, in a way that provides confidentiality of the breakthrough via the transactionalization of the search process, and to enable meta-coordination and optimization of global research efforts. In this alternative embodiment, the system 100 may use the distributed ledger for intellectual property 109 to declare and track IP ownership of incremental discoveries, with automated agreements for licensing and partnership arrangements for ancillary and related inventions. A triple entry self-auditing accounting system may optimize the licensing of resulting intellectual property, with integrated tracking of payments.

Yet another example of an alternative embodiment, the system 100 may be configured for operation in the area of crowd-sourcing integrated circuitry/chip design, also known as custom ASIC. This novel approach allows circuitry designers to more easily collaborate with others outside the user's organization—where confidentiality and intellectual property constraints—which often make it impossible to freely disclose internal discussions without significant managerial overhead—are automated. The system 100 may enable an automated entitlement capability to ensure that confidential information is not divulged, and paired with partial transparency tranactionalized searches, the system may allow for research teams to search for likely participants, releasing confidential information only under digitally executed confidentiality agreements. Designers may be able to upload designs and other intellectual property that integrates with analog layout, chip assembly functionality, and so forth. This enables “community-based silicon verification of intellectual property”.

Another example of an alternative embodiment, the system 100 may be configured to provide an open trust-enabled marketplace for products and services other than intellectual property-based services. Marketplaces are functional because of the existence of key trust proxies—from Dunn & Bradstreet reports to informal venture capital backchannel gossip—and this network of trust enables the acceleration of business. As the Internet diminishes the requirement of physical proximity, these proxies of trust are slowly replaced by online equivalents, enabling the formation of virtual business hubs. In other words, the next-Silicon Valley aggregator could be located within cyberspace. The system 100, in an alternative embodiment, may be used to create a new kind of electronic marketplace for venture formation and services, capable of accelerating business adoption for small and medium sized businesses within an emerging economic zone. Additionally, in an alternative embodiment, this may be expanded to limited transparency markets, where large or sensitive transactions can be pursued and completed privately.

Additionally, in this example of an alternative embodiment, the core process may be based on the establishment of a flexible “indication of interest” function that operates using partial transparency of information. This makes the search process two-way, and may allow the existence of solicited advertising, with compensation for reading such advertisements made more flexible with variable pricing. By providing a fair and equitable access method, optimized advertising will be enabled.

As another example of an alternative embodiment, the system 100 may include open super-directories. Traditionally, the greatest shortcoming of super-directories has been the tendency for such systems to prevent unsolicited messages, which means that this system could be tolerant of spam. By using the system's 100 capability to store profile information securely, it enables the usage of intelligent advertisements and dynamic marketplace technologies to mediate and compensate for access in a novel and more secure manner. In such an alternative embodiment, the user 101 may control their own consumer data, and thus, the individual may directly participate in any benefit derived from any inquiries placed against these identity servers. These identity services may be provided for a fee by either an authority or a for-profit third-party Identity Service Provider using a distributed ledger for identity.

In such an alternative embodiment, the user 101 allows a computerized process to manage their virtual identity, which we call the business identity management agent. This agent announces that a limited number of direct marketing requests will be accepted by this consumer or household and provides a secure disclosure of its auditable purchasing profile to all inquiring advertisers via a licensed profile evaluation service. Again, these evaluation servers 3300 may be licensed and regulated. For example, this access agent may state that its owner may be willing to accept ten pieces of direct marketing this week, for any form—electronic, marked and mailed, or confirmed telemarketing (most expensive). This access agent controls certain authenticated information about its owner: that historically out of, say, 2000 ads there were a certain number of purchasing events that resulted in purchases that aggregated to a certain cash volume, that a user belongs to a certain market segment, or that the head of household is also a director of information systems and manages IT spending for a Fortune 500 company. This leads to a much more accurate probability of sale per impact than is possible with current direct marketing technology. This probability of sale could be “validated” by an authority, and also, that authority could verify that the inquirer is not attempting to “game” the data from the agent. Gaming the system means to pursue unauthorized extraction of profile data, which could lead to the eventual dilution of the value of consumer profiling data and must be prevented to insure this business model.

In further alternative embodiments, the system 100 may use the trust object 901 stored in a trust object distributed ledger 902 for additional applications, including without limitation, two-way wi-fi authorization. For example, when a user 101 arrives at a hotel without a reservation, the system 100 may present a trust object 901 from a wallet of trust objects including hotel and airline loyalty programs or scan against the hotels offering of trust object partnerships, and automatically provide guest WiFi access to select users. Another example may be for the system 100 to scan all user's trust objects 901 for discounts or special treatment, based on memberships in certain clubs or acknowledgment of “platinum status” relationships. Another example may be for the system 100 to scan all incoming email for trust objects, to allow safe passage through spam prevention filters.

In further alternative embodiments, the system 100 may use trust objects 901 embedded into news articles, to provide a sense of the reliability of the source. In this way, the system 100 may address the “fake news” problem on the Internet today, by verifying the source and reliability of the chain of delivery, in a novel and more effective manner.

In further alternative embodiments, the system 100 may use an intelligent electronic postmark (ELM). Thus, any document postmarked with such a device, may be able to retrieve document management information about the file and its access history through the postmark, which may be stored on a distributed ledger. Such a capability may be of great utility in many areas, including healthcare records. Furthermore, the user interface of such a device may be an animated graphic that shows that the postmark is active.

In further alternative embodiments, the system 100 may provide for the user 101 to click a button or invoke an operation in his intellectual property wallet app to “promote” an idea, which will subtly seek potential partners and investors based on reputation and requests. There could be a small charge for promoting an idea, just like promoting a post on LinkedIn costs a bit of money. The underlying system may enable both search and reverse search advertising for ideas.

In further alternative embodiments, the system 100 may provide for the user 101 to click a button or invoke an operation in his intellectual property wallet app 703 to select an option or idea type equivalent to “open source” or “help the world”, which declares the idea to be open source, and potentially, to make promotion free.

In further alternative embodiments, the system 100 may provide for the user 101 to submit not an idea, but a challenge or problem set for others to solve, or a core idea that others can generate sub-ideas to. There could be funding or prize money attached to challenges, with specific and customizable rules.

In further alternative embodiments, the system 100 may extend the Micro-Equity Incentive functionality to manage equity compensation and investment for a company, or collection of companies and interests. In this system, financial reporting, such as balance sheets, P&L, cash flows, cap tables, are stored in a distributed ledger, with smart contract capabilities. A further example of an alternative embodiment, with special functionality, such as lockup agreements that are encoded into the blockchain system, so founders can't sell stock faster than they agreed during the initial offering of equity shares. Another example may be that if a company keeps its promise to issue regular reports and board meeting notes, it receives more trust objects, and the overall trust score increases. A further alternative embodiment is to include, in addition to financial reporting (like balance sheets, P&L, cash flows, cap tables, etc.), a special intellectual property valuation report, using information housed in the IP blockchain for that company, or a special risk profile report based on the Trust Objects collected, all of which are all automatically audited by distributed ledger triple entry accounting.

In further alternative embodiments, the system 100 may provide for certain users 101, or a multiplicity of collaborative users, to be able to split, merge and prune ideas in the IP blockchain.

In further alternative embodiments, the system 100 may be configured for the IP blockchain database 109 to use fields that align with international patent application models, with fields such as area of endeavor, background, abstract, brief summary, detailed description, connection of elements, description of variations and alternate embodiments, figures, claims, and index. The various fields may be viewable at different trust levels by the searcher, for example, abstract is searchable by trusted parties without NDA (non-disclosure agreement), brief summary is searchable under blanket NDA for the eco-system members, detailed description and research notes are searchable only under full NDA.

In further alternative embodiments, the system 100 may provide for improving the ability of users 101 to track and detect key intellectual property developments more effectively, including, without limitation: enabling ministries of commerce in nations to track the development of new technologies within their nations; enabling intellectual property managers in companies to track the development of new technologies; and enabling business leaders to identify emerging threats.

In further alternative embodiments, the system 100 may include a just-in-time instructional system. This system may use artificial intelligence to gauge situations when specific instructional content may have the highest positive impact in terms of “learning while doing”. The system monitors many factors about the learning context, including who is in a learning group, what the optimal process of learning is believed to be by domain experts, the absence or inclusion of certain key words or phrases in the online learning group, the overall velocity of collaboration and participation, and other factors. Using this, the system provides just-in-time video, and other training content, to rapidly instruct on the task at hand.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

It will be appreciated that some exemplary embodiments described herein may include one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the two approaches may be used. Moreover, some exemplary embodiments may be implemented as a computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), a Flash memory, and the like.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine-readable storage device, a machine-readable storage substrate, a memory device, a composition of matter effecting a machine readable propagated signal, or a combination of one or more of them.

A computer program (also known as a program, software, software application, application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors (computing device processors) executing one or more computer applications or programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, solid state drives, or optical disks. However, a computer need not have such devices.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network or the cloud. The relationship of client and server arises by virtue of computer programs running on the respective computers and having a client server relationship to each other.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution may cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The computer system may also include a main memory, such as a random access memory (RAM) or other dynamic storage device (e.g., dynamic RAM (DRAM), static RAM (SRAM), and synchronous DRAM (SDRAM)), coupled to the bus for storing information and instructions to be executed by processor. In addition, the main memory may be used for storing temporary variables or other intermediate information during the execution of instructions by the processor. The computer system may further include a read only memory (ROM) or other static storage device (e.g., programmable ROM (PROM), erasable PROM (EPROM), and electrically erasable PROM (EEPROM)) coupled to the bus for storing static information and instructions for the processor.

The computer system may also include a disk controller coupled to the bus to control one or more storage devices for storing information and instructions, such as a magnetic hard disk, and a removable media drive (e.g., floppy disk drive, read-only compact disc drive, read/write compact disc drive, compact disc jukebox, tape drive, and removable magneto-optical drive). The storage devices may be added to the computer system using an appropriate device interface (e.g., small computer system interface (SCSI), integrated device electronics (IDE), enhanced-IDE (E-IDE), direct memory access (DMA), or ultra-DMA).

The computer system may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system may also include a display controller coupled to the bus to control a display, such as a cathode ray tube (CRT), liquid crystal display (LCD) or any other type of display, for displaying information to a computer user. The computer system may also include input devices, such as a keyboard and a pointing device, for interacting with a computer user and providing information to the processor. Additionally, a touch screen could be employed in conjunction with display. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer system performs a portion or all of the processing steps of the invention in response to the processor executing one or more sequences of one or more instructions contained in a memory, such as the main memory. Such instructions may be read into the main memory from another computer readable medium, such as a hard disk or a removable media drive. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

As stated above, the computer system includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system, for driving a device or devices for implementing the invention, and for enabling the computer system to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code or software code of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

Various forms of computer readable media may be involved in carrying out one or more sequences of one or more instructions to processor for execution. For example, the instructions may initially be carried on a magnetic disk of a remote computer. The remote computer can load the instructions for implementing all or a portion of the present invention remotely into a dynamic memory and send the instructions over the air (e.g. through a wireless cellular network or WiFi network). A modem local to the computer system may receive the data over the air and use an infrared transmitter to convert the data to an infrared signal. An infrared detector coupled to the bus can receive the data carried in the infrared signal and place the data on the bus. The bus carries the data to the main memory, from which the processor retrieves and executes the instructions. The instructions received by the main memory may optionally be stored on storage device either before or after execution by processor.

The computer system also includes a communication interface coupled to the bus. The communication interface provides a two-way data communication coupling to a network link that is connected to, for example, a local area network (LAN), or to another communications network such as the Internet. For example, the communication interface may be a network interface card to attach to any packet switched LAN. As another example, the communication interface may be an asymmetrical digital subscriber line (ADSL) card, an integrated services digital network (ISDN) card or a modem to provide a data communication connection to a corresponding type of communications line. Wireless links may also be implemented. In any such implementation, the communication interface sends and receives electrical, electromagnetic or optical signals that carry digital data streams representing various types of information.

The network link typically provides data communication to the cloud through one or more networks to other data devices. For example, the network link may provide a connection to another computer or remotely located presentation device through a local network (e.g., a LAN) or through equipment operated by a service provider, which provides communication services through a communications network. In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit and receive data, including program code, through the network(s) and, the network link and the communication interface. Moreover, the network link may provide a connection through a LAN to a client device or client device such as a personal digital assistant (PDA), laptop computer, tablet computer, smartphone, or cellular telephone. The LAN communications network and the other communications networks such as cellular wireless and WiFi networks may use electrical, electromagnetic or optical signals that carry digital data streams. The processor system can transmit notifications and receive data, including program code, through the network(s), the network link and the communication interface.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

1. A method for providing a Merkle directed idea graph stored in a blockchain database, the method, comprising:
receiving a data set describing intellectual property;
creating a root node in a blockchain database comprising the data set;
calculating a hash value for the data set of the root node;
storing the hash value of the root node in the blockchain database;
receiving a commit data set describing changes to the data set describing the intellectual property;
calculating a hash value for the commit data set; and
storing and linking the commit data set hash to the hash value of the root node as a new branch of the idea graph in the blockchain database.

2. The method of claim 1, wherein a Merkle proof is performed to incrementally validate branches to determine if a branch has been modified.

3. The method of claim 1, wherein the commit data set is provided by a user having a reputation score, and wherein the reputation score of the user must be above a threshold for the storing and linking the commit data set hash to the hash value of the root node as a new branch of the idea graph.

4. The method of claim 1, wherein an adaptive and dynamic non-binary trust model is used to manage access to a data set describing intellectual property.

5. The method of claim 1, wherein a persistent and encapsulated software trust object is used to provide trust estimations for a user.

6. The method of claim 1, wherein the blockchain database is maintained via trust enabled adaptive mining.

7. The method of claim 1, wherein a micro-equity incentive is provided to a user providing a commit data set.

8. A method for performing a partial transparency transactionalized search of intellectual property, the method, comprising:
receiving data having a number of content fields which describe intellectual property;
receiving search term(s) for querying received intellectual property;
collecting data describing intellectual property having matching search terms;
determining which content fields of intellectual property having matching search terms to return to the searcher based on status and reputation of searcher; and
providing determined content fields of matching intellectual property to searcher.

9. The method according to claim 8, wherein options for improving the status of the searcher are provided to the searcher, and wherein the performance of the options increases the amount of content fields provided to the searcher.

10. The method of claim 8, wherein search suggestions are provided to the searcher, and wherein the search suggestions are based on incremental search queries and impact analysis for improving the searcher's status level.

11. The method of claim 8, wherein a token is charged, and wherein the token increases the amount of content fields provided to the searcher.

12. The method of claim 8, wherein the token is provided to an owner of the matching intellectual property.

13. The method of claim 8, wherein the data having a number of content fields which describe intellectual property is organized into different classifications via automatic ontology induction.

14. The method of claim 8, wherein the data describing the intellectual property is stored in a blockchain database.

15. A method for creating a licensing royalty smart contract with auditable automated payment tracking, the method comprising:
storing data in a blockchain database, the data describing terms for licensing and royalty requirements for collaboration in a root node of a Merkle directed graph that comprises a data set describing an intellectual property;
storing a commit data set in the blockchain database, the commit data set describing changes to the data set describing the intellectual property and data describing the user generating the commit data as a child node of the root node in the Merkle directed graph;
receiving data describing the achievement of the licensing and royalty requirements of the root node; and
storing data describing licensing and royalty payments to the user that provided the commit data set as another child node in the Merkle directed graph.

16. The method of claim 15, wherein automated disbursement of revenues and royalties is provided to the user that provided the commit data set.

17. The method of claim 15, wherein the data describing the achievement of the licensing and royalty requirements is used to generate reputation histories for all users that provided data that was stored in a node of the Merkle directed graph.

18. The method of claim 15, wherein a Merkle proof is performed to incrementally validate the nodes of the Merkle directed graph to determine if a node has been modified.

19. The method of claim 15, wherein the Merkle directed graph is maintained via trust enabled adaptive mining.

20. The method of claim 15, wherein the Merkle directed graph is a graph selected from an acyclical Merkle directed graph and a cyclical Merkle directed graph.
